(19) United States
(12) Patent Application Publication
(10) Pub. No.: US 2014/0207479 A1
(43) Pub. Date: Jul. 24, 2014

(54) System of Generating a Letter of Medical Necessity from a Specification Sheet

(71) Applicant: Conduit Technology, LLC, Erie, PA (US)

(72) Inventors: James Noland, Girard, PA (US); Christopher Mentch, Erie, PA (US)

(73) Assignee: Conduit Technology, LLC, Erie, PA (US)

(21) Appl. No.: 14/206,049

(22) Filed: Mar. 12, 2014

Related U.S. Application Data
(63) Continuation-in-part of application No. 12/691,065, filed on Jan. 21, 2010, now Pat. No. 8,712,800.

(51) Int. Cl. G06F 19/00

(52) U.S. Cl. CPC G06F 19/327
USPC 705/2

(57) ABSTRACT

A system is provided for generating a letter of medical necessity based upon a specification sheet. The system receives a specification sheet creation request from a vendor that includes information regarding a client, a clinician, a vendor, a physician, a primary equipment item, equipment accessories, a client assessment, client photos, customized comment fields, and client measurements. The specification sheet requires a final review for vendor verification and modification. Upon completion, the vendor submits the specification sheet, with a completion deadline, to the specified clinician. After the clinician is alerted to, and approves, the specification sheet, data from the specification sheet is imported to assist the clinician in drafting a letter of medical necessity. The clinician is required to modify template letter text, and upon completion, downloads the letter of medical necessity, whereupon the vendor is notified of the completion of the letter of medical necessity.

This application is a continuation-in-part of U.S. application Ser. No. 12/691,065, filed on Jan. 21, 2010, which takes priority from U.S. provisional application 61/146,345, filed on Jan. 22, 2009, which are both incorporated herein by reference.

### BACKGROUND

For clients requiring specialized equipment, insurance companies can require a letter of medical necessity (LMN). There are four main parties involved in obtaining specialized equipment for a client: (1) a physician, (2) a clinician, (3) a vendor, also known as a Rehab Technology Supplier or an RTS vendor, and (4) the client, also known as a customer or a patient. Writing the letter of medical necessity can be very time consuming (1-3 hours) for the clinician and often this is not reimbursed by third party payers. Typically, the clinician must take a Specification Sheet (spec sheet) in one format and convert it to another format to complete the letter of medical necessity. The spec sheet must be generated by the vendor in a consistent format, otherwise the resulting LMN from the clinician will be inadequate. Moreover, the clinician may not know how to write an LMN or understand the context of the need for the LMN, and therefore fail to provide all of the information required in a particular LMN to complete the review process. Therefore, a system is needed to improve the process of generating LMN's for clinicians.

### SUMMARY

A computer-implemented method, system, and/or non-transitory computer-readable medium are utilized for generating a specification sheet through an interface that utilizes a display device, comprising receiving a specification sheet creation request from a vendor, and receiving a data item comprising client name and gender, a clinician, and a vendor, wherein the interface provides a vendor self-selection option. Selection options are presented through the interface for an equipment purpose and a primary equipment category comprising manufacturers, general equipment types, and a no-primary item option. Vendor input is received that selects the equipment purpose and primary equipment, and a final review is provided with options to add, edit, and delete a data item that requires vendor input indicating validation of the data item. Vendor input is received that specifies, for the specification sheet, a customized comment field and a letter of medical necessity completion deadline, wherein the clinician's response is subsequently presented through the interface to the specification sheet, indicating acceptance or rejection requiring resubmission. After receiving acceptance through a network from the clinician, the interface sends a completion notification once the clinician has completed a letter of medical necessity that imports data items from the specification sheet. Each customized comment field comprises creating, prior to starting the instant specification sheet, a comment template based on an earlier specification sheet by identifying, within textual input associated with the prior specification sheet, each matching instance corresponding to data-types comprising a prior person's name, possessive versions of the prior person's name, and gender-specific pronouns matching the prior person's gender. Each matching instance is replaced with a placeholder corresponding to its matching data-type. The comment template is outputted, on the display device, by replacing each data-type placeholder with corresponding client data from the instant specification sheet.

In variations of the computer-implemented method, system, and/or non-transitory computer-readable medium for generating a specification sheet, the interface provides, for specification sheets associated with the vendor's account, a listing of the most recent specification sheets and searching for existing specification sheets by client name, specification sheet status, clinician, and physician.

In other variations of the computer-implemented method, system, and/or non-transitory computer-readable medium for generating a specification sheet, the equipment purpose further comprises presenting the vendor with selectable choices comprising acquiring new equipment, replacing existing equipment, and modifying existing equipment. If the vendor selects modifying or replacing existing equipment, the vendor is subsequently prompted to input information about the client's current equipment, and a customized comment field for client's current equipment.

In some embodiments of the computer-implemented method, system, and/or non-transitory computer-readable medium for generating a specification sheet wherein after receiving vendor input specifying completion of the final review, the interface provides options for the vendor to request client measurements, an assessment, or both, from the clinician.

In another embodiment, the computer-implemented method, system, and/or non-transitory computer-readable medium for generating a specification sheet presents an option to input, edit, and delete a data item comprising a client assessment.

In another variation, the computer-implemented method, system, and/or non-transitory computer-readable medium for generating a specification sheet presents a photo uploading option for a data item, wherein if input is received to upload photos, the interface receives text from the vendor associated with uploaded photos.

In variations of the computer-implemented method, system, and/or non-transitory computer-readable medium for generating a specification sheet presents an option to input, edit, and delete a data item comprising client measurements.

In other variations of the computer-implemented method, system, and/or non-transitory computer-readable medium for generating a specification sheet sends the clinician, based on vendor input, a deadline reminder or deadline modification.

In some embodiments of the computer-implemented method, system, and/or non-transitory computer-readable medium for generating a specification sheet, the interface presents, after a specification sheet rejection from the clinician, clinician comments and editable specification sheet data, and in response receives specification sheet resubmission from the vendor.

In another embodiment of the computer-implemented method, system, and/or non-transitory computer-readable medium for generating a specification sheet, a specification sheet data item comprises client information, a client evaluation date, and a primary item category comprising a manufacturer, an equipment-type, or an accessories-only category.

In another variation of the computer-implemented method, system, and/or non-transitory computer-readable medium for generating a specification sheet, a data item contains client information comprising client insurance information, client diagnosis, participants in a client evaluation whose sequence in the client evaluation is editable, and a physician, wherein the interface provides physician information retrieval from separate software when requested by the vendor.

In variations of the computer-implemented method, system, and/or non-transitory computer-readable medium for generating a specification sheet presents options to request that the clinician perform a client assessment, client measurements, or both.

In other variations of the computer-implemented method, system, and/or non-transitory computer-readable medium for generating a specification sheet, for the primary equipment category in a data item, if a manufacturer selection is received, equipment models are presented corresponding to the selected manufacturer, or indicating that the selected manufacturer only has accessory items. If a general equipment type selection is received, equipment-type choices are presented based upon the general equipment type, an option to create a new primary item, and a model number field or choices based upon the general equipment type entered, wherein if an option to create a new primary item selection is received, then the interface presents input fields for equipment type and model number. A customized comment field is presented and is selectable item accessory choices, searchable by name or code, organized according to accessory categories corresponding to the primary item, with an option to create a new accessory item, wherein each choice can be added or removed as a favorite, wherein if an option to create a new accessory item is received, then the interface presents fields for accessory name, code, category, and model.

In some embodiments of the computer-implemented method, system, and/or non-transitory computer-readable medium for generating a specification sheet, if the equipment purpose in a data item is equipment replacement or modification, the interface presents options to add additional current equipment, remove current equipment, and modify information regarding current equipment, comprising make, model, condition, client's current condition with respect to the current equipment, current equipment risk factors that are selectable or creatable, and a customized comment field.

In another embodiment, the computer-implemented method, system, and/or non-transitory computer-readable medium for generating a specification sheet providing status updates for specification sheets associated with the vendor's account.

In another variation of the computer-implemented method, system, and/or non-transitory computer-readable medium for generating a specification sheet, the customized comment field further comprises presenting the vendor with selectable comment templates that the vendor can preview or place within a text field in the customized comment field, and presenting the vendor with selectable options to save text within the text field as a new comment template, and update the currently selected comment template with the text currently in the text field.

In other variations of the computer-implemented method, system, and/or non-transitory computer-readable medium for generating a specification sheet, the interface provides stock justification text for vendor-selected equipment.

A computer-implemented method, system, and/or non-transitory computer-readable medium are utilized for generating a letter of medical necessity through an interface that utilizes a display device, comprising notifying a clinician of a specification sheet from a vendor specifying the clinician and containing a deadline, and receiving a response from the clinician through a network that indicates acceptance or rejection of the specification sheet, wherein the interface sends the response to the vendor. After receiving an acceptance response from the clinician, the interface presents the clinician with potential data item matches from an account associated with the clinician that correspond to a data item type in the specification sheet, an option to create a data item utilizing a data item of the same data item type from the specification sheet, and an option to create a data item without specification sheet data. A final review is provided with options to add, edit, and delete a data item that requires clinician input indicating validation of the data item. Vendor comments associated with a data item to the clinician are provided, wherein the data item corresponds to a specification sheet data item containing the vendor comments. The clinician is presented with letter of medical necessity download options, wherein the vendor is notified of the clinician's letter of medical necessity download. Each customized comment field comprises creating, prior to starting the instant letter of medical necessity, a comment template based on an earlier letter of medical necessity by identifying, within textual input associated with the prior letter of medical necessity. Each matching instance corresponds to data-types comprising a prior person's name, possessive versions of the prior person's name, and gender-specific pronouns matching the prior person's gender. Each matching instance is replaced with a placeholder corresponding to its matching data-type. The comment template is outputted, on the display device, by replacing each data type placeholder with corresponding client data from the instant letter of medical necessity.

In variations of the computer-implemented method, system, and/or non-transitory computer-readable medium for generating a letter of medical necessity, the interface provides the clinician, prior to the response, a selectable preview of the specification sheet.

In other variations of the computer-implemented method, system, and/or non-transitory computer-readable medium for generating a letter of medical necessity, upon receiving a rejecting response, the interface presents the clinician with a comment field for text to accompany the response and requires the vendor to resubmit the specification sheet to the clinician.

In some embodiments of the computer-implemented method, system, and/or non-transitory computer-readable medium for generating a letter of medical necessity, prior to receiving a specification sheet notification, the interface presents an option to the clinician to create preliminary text, for either a new client or an existing client, wherein the preliminary text is added to a letter of medical necessity after acceptance of a specification sheet by the clinician.

In another embodiment of the computer-implemented method, system, and/or non-transitory computer-readable medium for generating a letter of medical necessity, the interface provides the clinician an option to create a letter of medical necessity prior to accepting a specification sheet.

In another embodiment of the computer-implemented method, system, and/or non-transitory computer-readable medium for generating a letter of medical necessity, the interface provides an option to undo an automated match of a data item in the specification sheet with a corresponding item associated with the clinician's account.

In variations of the computer-implemented method, system, and/or non-transitory computer-readable medium for generating a letter of medical necessity, a data item comprises a client, a physician, primary equipment, and a vendor, wherein the interface indicates whether the vendor in the specification sheet matches the vendor that submitted the specification sheet.

In other variations of the computer-implemented method, system, and/or non-transitory computer-readable medium for generating a letter of medical necessity, the interface presents optional data items, that if included in the specification sheet, comprise client assessment, client measurements, client photos, and text accompanying the client photos, wherein the interface provides the clinician with an option to input new versions of these data items.

In some embodiments of the computer-implemented method, system, and/or non-transitory computer-readable medium for generating a letter of medical necessity, the interface notifies the clinician of a deadline reminder from a vendor, a deadline modification by a vendor, and a deadline that exceeds a temporal proximity threshold, or has been reached or exceeded.

In another embodiment, the computer-implemented method, system, and non-transitory computer-readable medium for generating a letter of medical necessity, the interface pre-populates data item fields corresponding to specification sheet data item fields.

In another embodiment, the computer-implemented method, system, and/or non-transitory computer-readable medium for generating a letter of medical necessity, the download options include a letterhead option and comprise the letter of medical necessity, an assessment only, a combined assessment and justification, and an addendum to the assessment and seating and mobility evaluation.

In variations of the computer-implemented method, system, and/or non-transitory computer-readable medium for generating a letter of medical necessity, the interface provides an option to add a resource comprising a title, a URL, and a description, and an option to associate a resource with a diagnosis or a piece of equipment, with a resource rating option.

In other variations of the computer-implemented method, system, and/or non-transitory computer-readable medium for generating a letter of medical necessity, the interface provides options to add, edit, and delete pre-populated data from the specification sheet comprising client information, the vendor, a physician, client evaluation date, optional client measurements, client insurance information, client prognosis, the sequence of client evaluation participants, and clinician, including a co-signing clinician option.

In some embodiments, the computer-implemented method, system, and/or non-transitory computer-readable medium for generating a letter of medical necessity further comprises a photo interface that includes photo upload and deletion options, a text field associated with each photo, and a photo from the specification sheet with associated vendor text.

In another embodiment of the computer-implemented method, system, and/or non-transitory computer-readable medium for generating a letter of medical necessity, the interface provides an option to edit an existing equipment data item pre-populated from the specification sheet by adding current equipment or presenting selectable equipment associated with the clinician's client record.

In another embodiment of the computer-implemented method, system, and/or non-transitory computer-readable medium for generating a letter of medical necessity, the customized comment field further comprises presenting the clinician with selectable comment templates that the vendor can preview or place within a text field in the customized comment field, and presenting the clinician with selectable options to save text within the text field as a new comment template and update the currently selected comment template with the text currently in the text field.

In some embodiments of the computer-implemented method, system, and/or non-transitory computer-readable medium for generating a letter of medical necessity, the interface provides pre-generated text for a primary equipment data item within a customized comment field, wherein the pre-generated text utilizes template text associated with each particular primary equipment item and requires clinician validation. The interface also provides options to add, edit, and delete a data item that comprises an equipment data item and its associated customizable comment field, and to rearrange the order of appearance of equipment data items in the letter of medical necessity.

In another embodiment, the computer-implemented method, system, and/or non-transitory computer-readable medium for generating a letter of medical necessity, the interface provides pre-generated text for textual data items comprising introductory text, general justification text, and narrative text specific to a client identified in the specification sheet based upon the clinician's text previously generated for the client by the clinician, wherein the clinician is required to customize a textual data item, and wherein the interface provides an option for a customized comment field for a textual data item.

Those skilled in the art will realize that this invention is capable of embodiments that are different from those shown and that details of the devices, media, and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 depicts a networked computing environment for accessing online accounts.

FIG. 2 is a screenshot of an account login interface.

FIG. 3 is a spec sheet generation flow chart.

FIG. 4 is a screenshot depicting a spec sheet creation interface.

FIG. 5 is a screenshot depicting an interface to add a new client.

FIG. 6 is a screenshot depicting selection of primary equipment category.

FIG. 7 is a screenshot depicting selection of a new client's date of birth.

FIG. 8 is a screenshot depicting an interface to review client information.

FIG. 9 is a screenshot depicting an interface to add/edit detailed client information.

FIG. 10 is a screenshot depicting an interface add/edit to diagnosis, insurance, and clinician's account information.

FIG. 11 is a screenshot depicting an interface to add/edit physician, vendor, and client evaluation information.

FIG. 12 is a screenshot depicting an interface to add/edit new client equipment items.

FIG. 13 is a screenshot depicting an interface to create a new equipment item.

FIG. 14 is a screenshot depicting an interface regarding the client's current equipment.

FIG. 15 is a screenshot depicting an interface to add the client's current equipment.

FIG. 16 is a screenshot depicts text being imported into a customized comment field.

FIG. 17 is a screenshot depicting original text being added to a customized comment field.

FIG. 18 is a screenshot depicting a completed equipment item with an accompanying customized comment text field.

FIG. 19 is a screenshot depicting an interface presenting a text template with a new client's information applied to placeholders.

FIG. 20 is a screenshot depicting an interface to add a client seating and mobility assessment.

FIG. 21 is a screenshot depicting further details of an interface to add a client seating and mobility assessment.

FIG. 22 is a screenshot depicting an interface to upload client photos.

FIG. 23 is a screenshot depicting an interface to add client measurements.

FIG. 24 is a screenshot depicting fields in an interface to add client measurements.

FIG. 25 is a screenshot depicting a final spec sheet review with editable fields regarding evaluation date, client information, and diagnoses.

FIG. 26 is a screenshot depicting a final spec sheet review with editable fields regarding insurance information, current equipment, client assessment, and subject.

FIG. 27 is a screenshot depicting a final spec sheet review with editable fields regarding a primary item, an item list, and a clinician.

FIG. 28 is a screenshot depicting a final spec sheet review with editable fields regarding a note to the clinician's account regarding an equipment item.

FIG. 29 is a screenshot depicting a final spec sheet review with editable fields regarding a physician, a vendor, and evaluation participants.

FIG. 30 is a screenshot depicting a final spec sheet review with editable fields regarding client photos and sitting measurements.

FIG. 31 is a screenshot depicting a spec sheet submission interface with editable fields for data to accompany the spec sheet submission to the specified clinician.

FIG. 32 is a spec sheet submission confirmation screenshot.

FIG. 33 is a screenshot depicting an interface to send a reminder to the specified clinician.

FIG. 34 is a screenshot depicting an interface to modify the spec sheet status.

FIG. 35 is a screenshot depicting an interface for the vendor to send and receive discussion comments from the specified clinician's account regarding the spec sheet.

FIG. 36 is a screenshot depicting spec sheet rejections.

FIG. 37 is a screenshot depicting vendor notifications regarding submitted spec sheets.

FIG. 38 is an LMN generation flow chart.

FIG. 39 is a screenshot depicting notifications associated with a clinician account.

FIG. 40 is a screenshot depicting and LMN status numbers and an option for manual LMN creation.

FIG. 41 is a screenshot depicting options for manual LMN creation and client quickstart.

FIG. 42 is a screenshot depicting a spec sheet preview.

FIG. 43 is a screenshot depicting spec sheet rejection.

FIG. 44 is a screenshot depicting spec sheet acceptance.

FIG. 45 is a screenshot depicting options to match client data from the spec sheet with the clinician's records.

FIG. 46 is a screenshot depicting the matching of spec sheet data with the clinician's records.

FIG. 47 is a screenshot depicting medical resources that can be added/edited for the LMN.

FIG. 48 is a screenshot depicting a final review of data for the LMN.

FIG. 49 is a screenshot depicting discussion text associated with the LMN.

FIG. 50 is a screenshot depicting LMN final review pertaining to current equipment, client assessment, and an LMN subject.

FIG. 51 is a screenshot depicting vendor posted-notes containing vendor text.

FIG. 52 is a screenshot depicting the editing of current equipment along with a customized comment field.

FIG. 53 is a screenshot depicting the editing of a customized comment field for current equipment.

FIG. 54 is a screenshot depicting intro text and general justification text options, along with primary item options.

FIG. 55 is a screenshot depicting the editing of intro text and general justification.

FIG. 56 is a screenshot depicting edit options regarding an item list, closing text, a specified clinician, and a specified physician.

FIG. 57 is a screenshot depicting edit options regarding a specified RTS vendor, client evaluation participants, client photos, and client measurements.

FIG. 58 is a screenshot depicting an interface for adding resources and downloading the LMN.

FIG. 59 is a screenshot depicting download options for the LMN.

FIG. 60 is a screenshot depicting a sample LMN.

FIG. 61 is a block diagram of an embodiment of a computer system that can function in one or more embodiments disclosed herein.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

In the field of medical requisition, vendors of specialized medical and rehabilitative equipment must often provide an LMN to obtain approval, and ultimately payment, from the insurance provider of a client. LMN creation has traditionally placed an unnecessarily heavy burden upon the clinician, who may already have drafted other LMNs for the same client and/or equipment. After the vendor sends all the pertinent information regarding the client and equipment to the clinician, it is up to the clinician's account to piece together a highly-customized LMN. This common scenario introduces unnecessary delays, inefficiency, redundancy, and quality issues for each LMN. However, the computer-implemented system, method, and computer-readable medium disclosed herein provides a way for vendors to provide clinicians with standardized information about a client and the necessary equipment within an electronic spec sheet. Based on the data in the spec sheet, as well as the clinician's own previous LMNs and records, the clinician can produce an LMN in a much more efficient manner, with a much higher and consistent quality. In this way, the clinician need not “reinvent the wheel” every time they need to write an LMN.

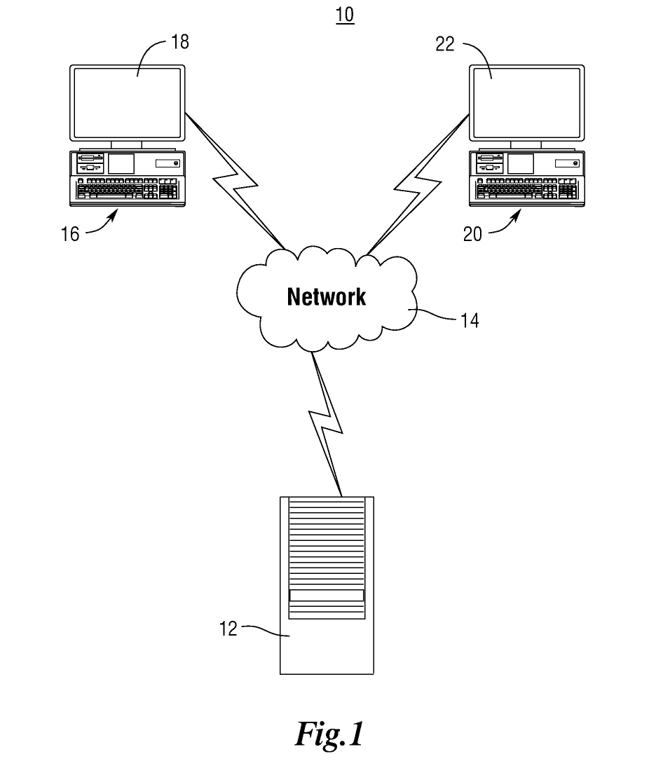

FIG. 1 shows an embodiment utilizing a networked environment 10, wherein a server 12 is remotely connected through a network 14 to a client device 16 utilized by a vendor, as well as a client device 20 utilized by a clinician through the same or a different network 14. The vendor utilizes their client device 16 to remotely access their online vendor account 18 that is stored on the same or a different server 12. Similarly, a clinician utilizes their client device 20 to remotely access their online clinician account 22 stored on the same or a different server 12. Client devices and servers as depicted can be any type of computing device. Any number of servers, or other computing devices, in any combination, can be utilized in any appropriate configuration, to provide clinicians and vendors with remote access to their respective online accounts.

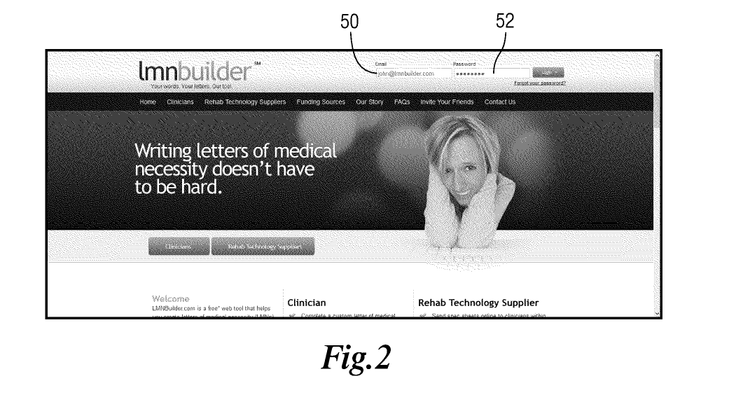

In accordance with this embodiment, online accounts must first be generated for vendors and clinicians, with vendors having a vendor-type account, and clinicians having a clinician-type account. Once generated, both types of online accounts can use any appropriate method for online authentication including, but not limited to, password(s), biometric authentication(s), periodically/randomly-generated PIN(s), and/or CAPTCHA(s). FIG. 2 depicts an embodiment of an interface requiring a username 50 and a password 52 for authentication. Any account login interface can optionally utilize a role-selection field (not shown) as well, which could allow the user to specify whether they have a vendor or clinician account. Activities involving protected client data require a secure online account, and secure data transmission, to comply with The Health Insurance Portability and Accountability Act of 1996 (HIPAA). To achieve HIPAA compliance, both vendor-type and clinician-type accounts provide secure data storage and transmission. However, many aspects described herein do not utilize such client information, and therefore those aspects can utilize any manner of transmittal and/or notification, including (but not limited to) unsecured email, text message, internet/IP-based messaging, phone call, pager, etc. (all are hereinafter designated as a notification). Therefore, both vendors and clinicians are required to utilize their secure online account for aspects that involve protected client data, but not for other aspects herein. Therefore, no element or limitation should be construed as requiring the utilization of a secure online account, or secure data transmission, unless it utilizes client data protected under HIPAA. In some embodiments, any text field can utilize a text-clearing option whereby a user can clear any text currently in the text field, regardless of whether the text was entered by the user or pre-populated.

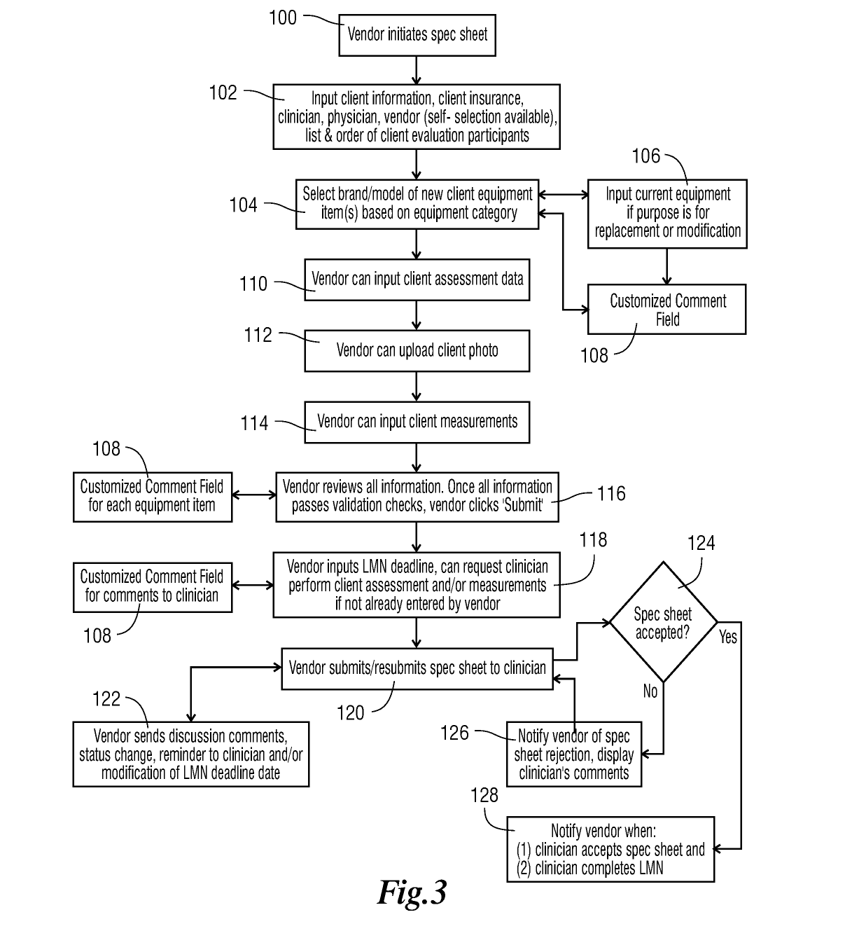

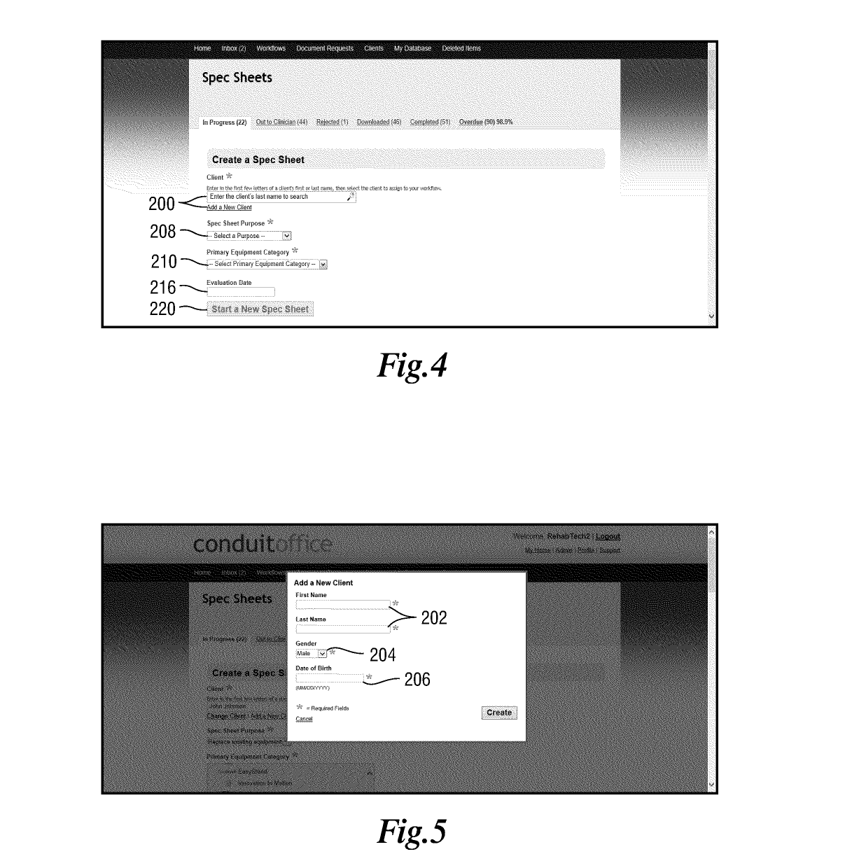

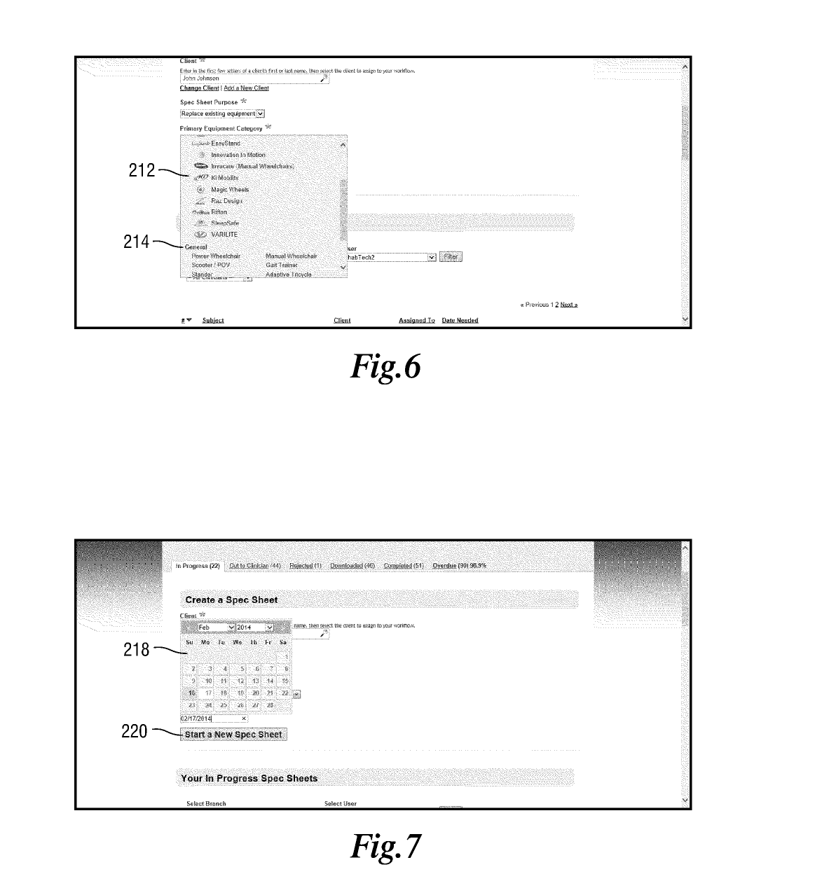

FIG. 3 depicts a flow chart disclosing the generation of a spec sheet. In FIG. 3, the vendor initiates a new spec sheet 100. FIG. 4 is a screenshot depicting an embodiment for the initialization of a spec sheet, where the vendor can search for an existing client's name or add a new client 200. Text searching described herein can be performed based upon partial information, such as the first few letters in a client's name. Adding a new client, further depicted in the screenshot in FIG. 5, requires the new client's name 202, gender 204, and date of birth 206. In some embodiments, with respect to the term ‘client name’ as used herein, any combination(s) of first, middle, and/or last name(s), along with prefix(es), suffix(es), and/or title(s) can comprise a client name. Returning to FIG. 4, the vendor inputs or selects a spec sheet purpose 208, which in this embodiment includes choices for new equipment, replacing existing equipment, and modifying existing equipment. In this embodiment, fields may optionally be denoted as required fields, for example, with an asterisk, although any type of denotation can be utilized, and a required field need not display any denotation. Existing equipment refers to the client's current equipment. The vendor further selects a primary equipment category 210. As depicted in FIG. 6, the vendor can select, for example, an equipment brand/manufacturer 212, a general equipment type 214, or an option for no primary equipment category (not shown). Returning to FIG. 4, the vendor further specifies a client evaluation date 216, as shown in more detail in the screenshot depicted in element 218 of FIG. 7. The method of input of any date described herein can utilize any suitable date-inputting interface, and is not limited to the depiction in FIG. 7 and/or other figures depicted throughout. As depicted in FIGS. 4 and 7, the vendor can click a button 220, for example, to signify completion of the initial spec sheet creation screen.

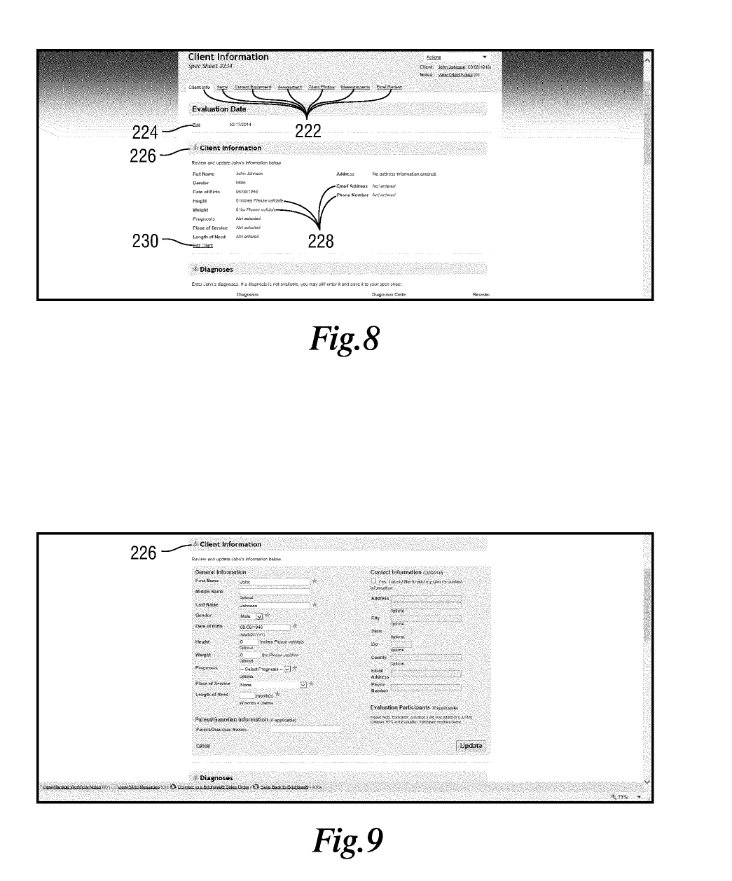

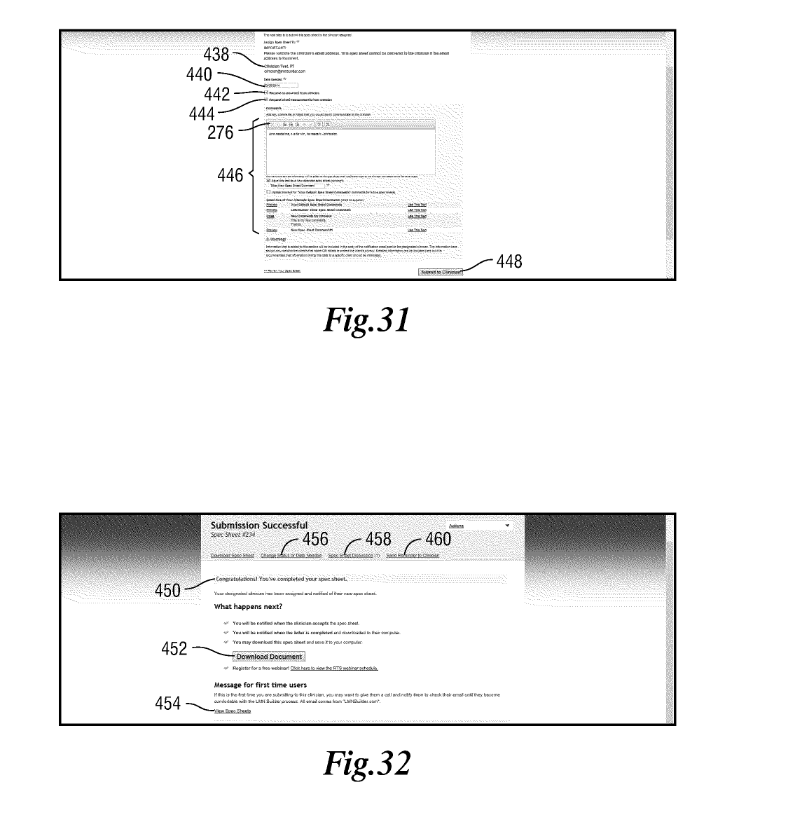

Returning to FIG. 3, the vendor in 102 then inputs client information, client insurance, clinician, physician, vendor (self-selection available), as well as a listing and order of client evaluation participants. FIG. 8 depicts a screenshot where the vendor can input more detailed information regarding the client. In this embodiment, once the vendor enters the ‘Client Information’ screen as shown in FIG. 8, they have on-demand access, through heading links 222, to the interface screens depicted in FIGS. 9-31. Specifically, access through these heading links is provided to the vendor until they complete the verification of the final review information as discussed below and depicted in FIG. 31. In other embodiments, heading links 222 may not be used.

Returning to FIG. 8, the vendor can modify the previously specified evaluation date 224. The vendor is alerted to the status of the client information currently known. The status of an individual field can cause an entire field grouping, such as ‘Client Information’ to display an alert icon 226, for example, or prevent the vendor from advancing from the current interface screen, as a type of form-validation, for example. The status 228 of individual fields such as client height, weight, email address, and phone number, as shown, can display a status such as ‘Please validate’ or ‘not entered,’ for example. The vendor can select an option to edit client information 230, which in an embodiment presents a more detailed screen to enter/modify the client information. FIG. 9 depicts a client information interface with the status indicator 226 previously discussed for FIG. 8.

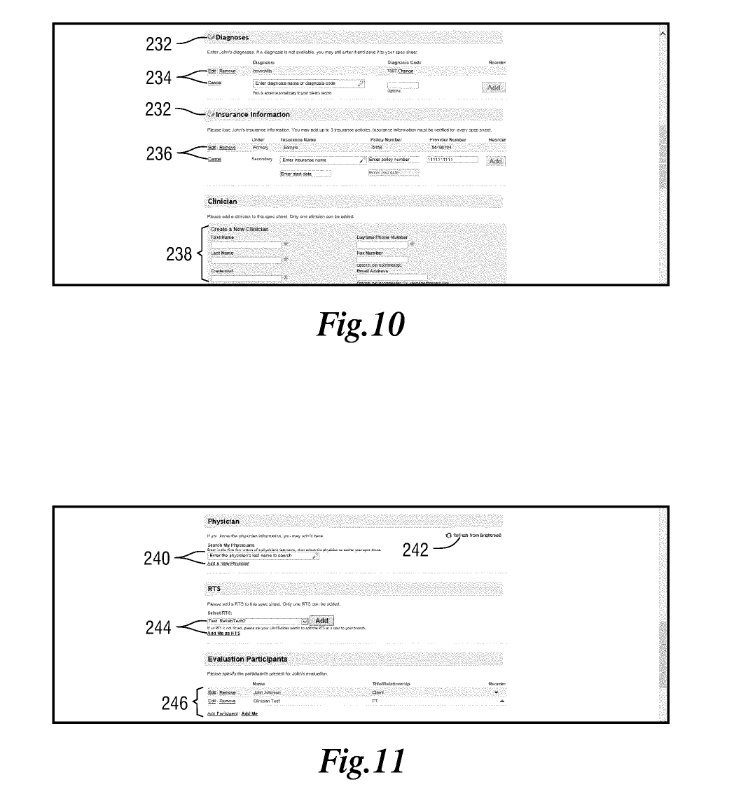

FIG. 10 displays a completion icon 232, wherein the vendor can specify one or more client diagnoses 234, along with an optional diagnosis code for each diagnosis. The vendor can also enter client insurance information 236 for one or more client insurance providers. This insurance provider information can include insurance type (primary, secondary, etc.), insurance provider's name (which can be searched for or entered manually), policy number, and provider number, wherein the order of insurance providers can also be re-ordered. The vendor can also search for a clinician record or input clinician data 238 that includes, for example, the clinician's name, credentials, phone number, fax number, and email address. In FIG. 11, the vendor searches for an existing physician record or input a new physician 240. In addition, the vendor can obtain and/or refresh 242 physician data from data providers such as BRIGHTREE®. The vendor also specifies an RTS vendor 244. In one embodiment the vendor can specify themselves as the designated RTS vendor with an ‘Add Me as RTS’ option, which can populate the RTS data 244 with the vendor's information associated with their vendor account. The vendor can also specify client evaluation participants 246. In this embodiment the vendor can add/edit/delete participants, and rearrange their listed order. Moreover, the interface presents the vendor with an ‘add me’ option for selecting a vendor participant.

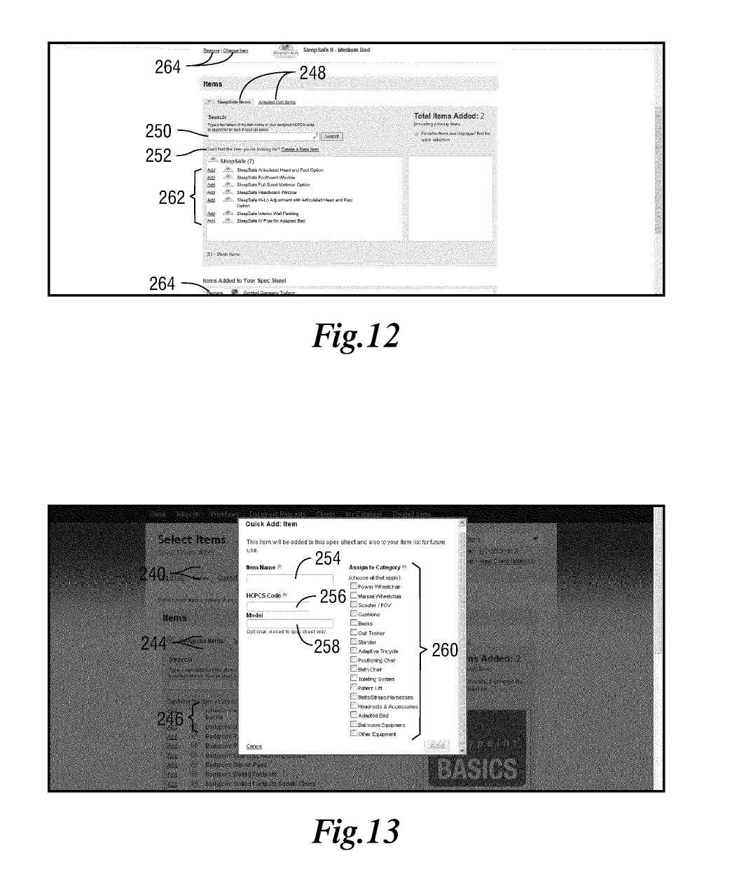

Returning to FIG. 3, the vendor in 104 selects new client equipment items. In FIG. 12, equipment items pertaining to the client can be presented according any type of logical grouping(s)/heading(s) 248, for example, brand/manufacturer and/or equipment item type groupings/headings. Other equipment categories (not shown) pertaining to equipment that relates to the current grouping can also be selectable, as can any other type of equipment group. The vendor can search 250 for equipment items. In an embodiment, the vendor can also add a new equipment item 252, which can produce an interface as shown in FIG. 13. Here, the vendor provides/selects an equipment name 254, a Healthcare Common Procedure Coding System (HCPCS) code 256, an equipment model number 258, and an equipment category 260. Returning to FIG. 12, the vendor can select an equipment item according to the brand/manufacturer and/or equipment type 262 that corresponds to the data the vendor provided previously for 212 or 214. Once the vendor adds an equipment item, there is are options 262 to modify or remove the designated equipment item, as the vendor is presented with options to add more new equipment items.

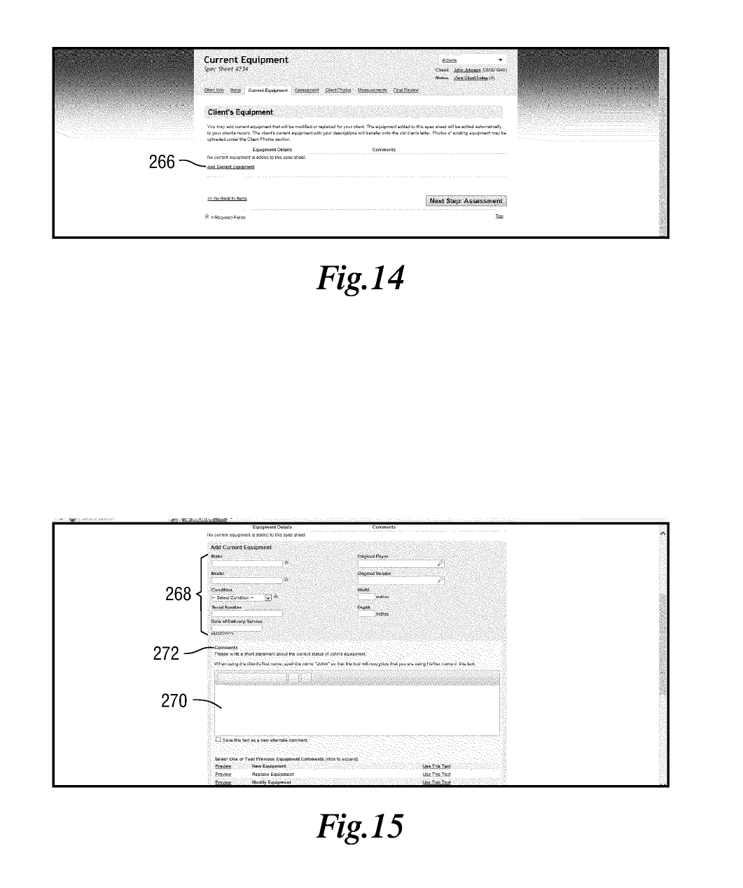

Returning to FIG. 3, the vendor inputs the client's current equipment in 106 if the vendor previously specified the spec sheet purpose 208 in FIG. 4 to involve replacing/modifying the client's current equipment. For example, in FIG. 14 the vendor can choose to add information regarding such current equipment 266. FIG. 15 shows a sample interface 268 for a vendor to enter information regarding the client's current equipment, for example, the current equipment's make, model, condition, date of delivery/service, original payor, original vendor, and/or the equipment's height/width. Any unit of measurement described herein can be of any appropriate unit type of measurement, such as metric or English units of measure. Additionally, the vendor can be presented with a blank comment text field 270 to create a customized comment field 272.

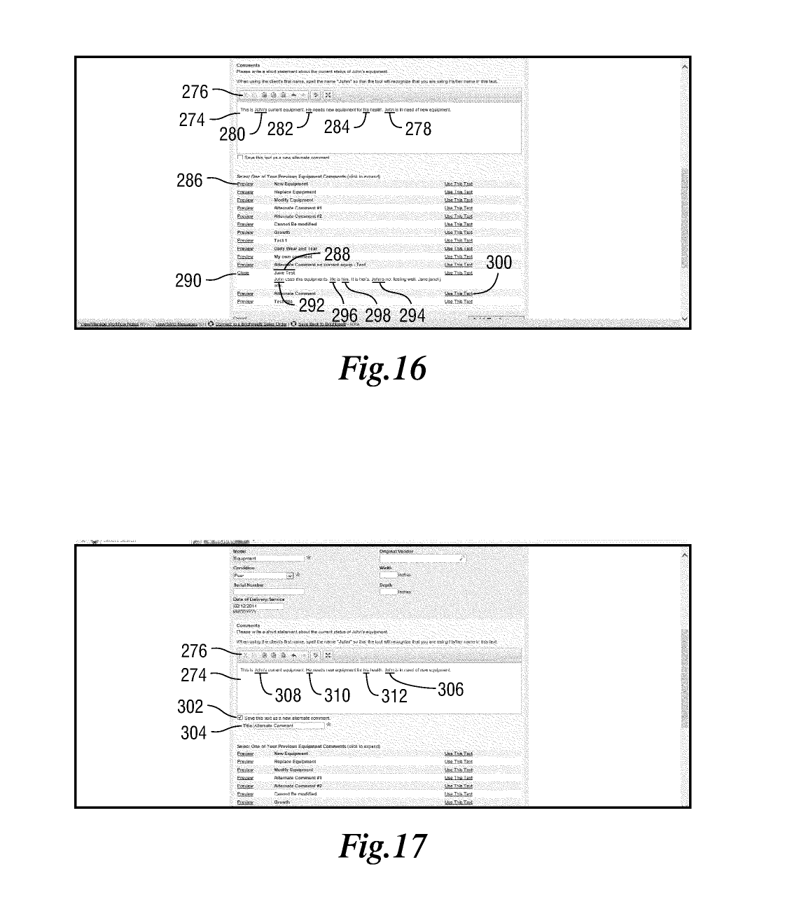

Returning to FIG. 3, the vendor can utilize a custom comment field 108. FIG. 16 depicts a comment field 274 containing textual input from the vendor. The interface can present any number of text editing options 276 for any textual field described herein. Text editing options 276 can be presented as icons or as any other type of suitable selectable options, and can include, for example: cut, copy, paste, paste as plain text, text color, text size, subscript, superscript, paste from another program such as WORD®, font, special characters, paste with source formatting, paste with destination formatting, paste with mixed formatting, undo, redo, spell-check, bold, italicize, underline, strike-through, highlighting, bullet-points, line spacing, text justification/alignment, text tables, and/or field enlargement.

Text entered into the comment field 274 can be parsed in real-time, periodically, or based upon input received from the vendor to indicate that the text is ready to be parsed and/or saved. Parsing is performed when creating a template version of the text within the comment text field 274. Parsing comment field text involves identifying, for example, instances of the client name 278 that match what was previously entered by the vendor 202 as previously shown in FIG. 5, or as identified by the vendor 200 through a search of existing client records, as previously shown in FIG. 4. Returning to FIG. 16, the client's name ‘John’ 278 has been entered by the vendor within the comment field text 274. Based upon the stored client name, each instance of the client's name 278 within the comment field text 274 is automatically replaced with a name placeholder (not shown).

Any type of placeholder described herein can be either visible or invisible to users. In this embodiment, the text is not visibly modified to display or indicate any type of placeholder, but such visibility can be utilized in other embodiments. In this embodiment, each instance of the client's first name is replaced with a name placeholder denoting that the client's first name was utilized within a particular location within the body of text as entered by the vendor.

In this embodiment, each instance of a possessive version of the client's first name 280 can also be replaced with a possessive name placeholder denoting that a possessive version of the client's first name was utilized in a particular location within the comment field text 274. As an illustration, within the comment text field 274 in FIG. 16, the vendor has entered a possessive version 280 of the client's name, here ‘John's.’ A possessive placeholder can be utilized regardless of whether the possessive version of a name is possessive or a contraction of the client name combined with ‘is.’

With respect to name placeholders and/or possessive name placeholders as described herein, such placeholders are utilized for instances of the client's first name and/or possessive instances of the client's first name. In other embodiments, with respect to name placeholders and/or possessive name placeholders, any combination(s) of first, middle, and/or last name(s), along with prefix(es), suffix(es), and/or title can be utilized and analyzed for any parsing, analysis, and/or text replacement features described herein. The utilization of a name placeholder and/or possessive name placeholder can be either case-sensitive or non-case-sensitive.

With respect to this embodiment, parsing the comment field text 274 can further involve identifying instances of pronouns 282 and 284 that match the stored client gender, either as previously entered/selected by the vendor 204 as shown in FIG. 5, or as identified by the vendor 200 through a search of existing client records as shown in FIG. 4. Based upon the stored client gender, pronouns 282 and 284 that corresponds to the client's gender, within the vendor's text in the comment field 274, can also be replaced with a placeholder (not shown). In other embodiments, placeholders can also be applied to pronouns 282 and 284 within the comment field text 274, regardless of the gender of the pronoun, wherein a placeholder can be applied by storing the grammatical pronoun type. The utilization of a gender-specific pronoun can be either case-sensitive or non-case-sensitive. In any event, the grammatical pronoun type is also stored within a pronoun placeholder. If a subject pronoun, such as ‘he,’ appears within the comment field text, the placeholder will store the grammatical pronoun type. Any appropriate grammatical pronoun type can be utilized, such as subject pronouns, object pronouns, possessive pronouns, and reflexive pronouns.

If the vendor selects a preview option 286 to preview template text, the vendor can view how the template text will appear with the current client's information applied. Here the vendor has chosen to view the template preview text 288 titled ‘Jane Test,’ which then displays a modified template. At any time the vendor can choose a ‘close’ option 290 to hide or collapse the preview text. In this embodiment the vendor can have as many template previews open as desired, although the number of preview templates open simultaneously can be restricted in other embodiments. The template preview text applies the current client's name, possessive name, gender, and grammatical pronoun type to placeholders (not shown) with respect to client name, possessive client name, and pronouns. For example, the first word in this modified template utilizes the current client's name of ‘John’ 292 where a name placeholder had been utilized. The name ‘John’ 292 is displayed in the location within the text where a name placeholder was located. Similarly, this modified template utilizes a possessive form of the client's name, so that ‘John's’ 294 is displayed in the location within the text where a possessive name placeholder was located. The pronouns ‘he’ 296 and ‘him’ 298 are also displayed within this modified template. Here, the client's gender is male, which when combined with a pronoun placeholder designating a subject pronoun, produces the pronoun ‘he’ 296. Similarly, combining a pronoun placeholder designating an object pronoun with the same client's male gender information produces the pronoun ‘him’ 298. In this embodiment the interface presents a ‘Use This Text’ 300 option, which places the textual template in the comment field 274. In this embodiment, multiple textual templates can be placed in the comment field 274 in this way.

In FIG. 17, regardless of whether the vendor uses template text or writes entirely new text, there is a template save option 302 which can cause a title field 304 to appear, where the vendor can then input a title for this comment field text 274. If the vendor selects the option to save this comment field text 274 as a template, placeholders (as described above) will be placed in the specific locations of the text they replace, if and/or where appropriate. Here this customized textual comment utilizes the client's name ‘John’ 306, a possessive version of the client's name ‘John's’ 308, a subject pronoun ‘he’ 310, and a possessive pronoun ‘his’ 312.

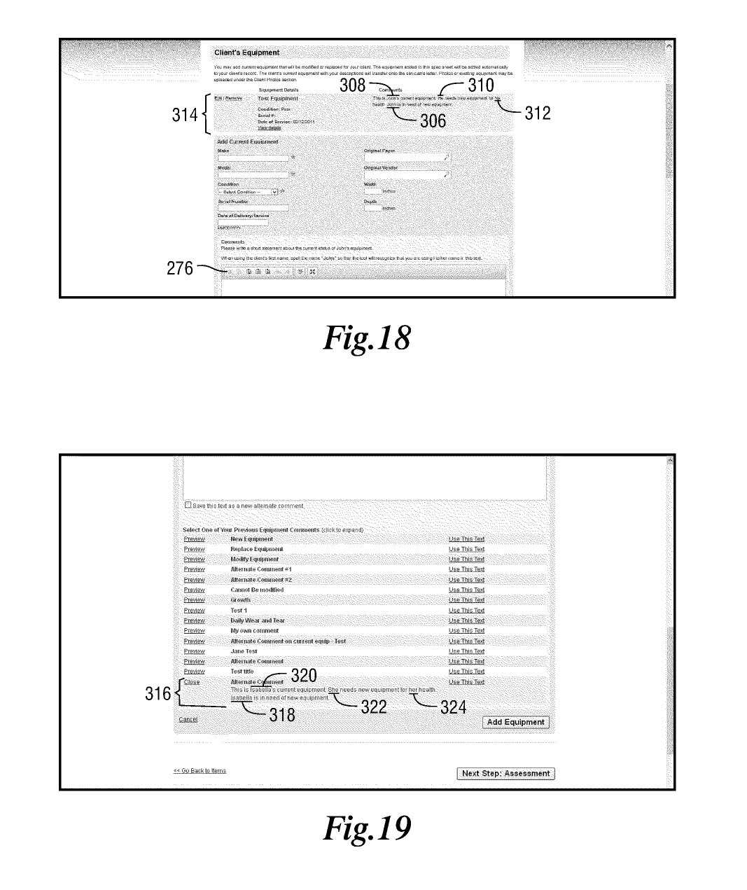

FIG. 18 depicts a completed current equipment item 308 including a customized comment from the vendor, along with options to edit and remove the client equipment item. Additionally, the comment text has placeholders (not shown) associated with words in the comment text corresponding to elements 306-312. FIG. 19 depicts the comment text that the vendor previously created in FIGS. 17-18 now being used as a modifiable template 316 for a different client. Instead of being just a static textual comment for client John, here the template is shown being subsequently utilized for another client, Isabella. Here, the client's name, Isabella 318, has been applied to the name placeholder that based on the utilization of John's name 306. This generates Isabella's name 318 in the same location where John's name 306 originally was within the customized template. Similarly, Isabella's name is applied to a possessive name placeholder to generate a possessive version of her name 320 where a possessive version of John's name 308 was originally located. Moreover, Isabella's specified gender, female, is combined with pronoun placeholders in this same modified template. Where the subject pronoun ‘he’ 310 was originally located for John, the pronoun placeholder combines the fact that this was a subject pronoun with Isabella's specified gender to generate a more appropriate object pronoun, ‘she’ 322. Similarly, where the possessive pronoun ‘his’ 312 was originally located for John, the pronoun placeholder combines the fact that this was a possessive pronoun with Isabella's specified gender to generate a more appropriate possessive pronoun, ‘her’ 324. In this embodiment, a vendor can utilize any template text associate with their vendor account, regardless of whether the template was based on text utilized for the same client or a different client. Moreover, placeholders can be generated for any type of third-person pronouns, including possessive pronouns and reflexive pronouns.

Returning to FIG. 4, if the vendor previously specified the spec sheet purpose 208 to not involve any current client equipment, such as the option to ‘acquire new equipment,’ then the vendor can add a customized comment field pertaining to the new equipment item(s). Under this scenario, the customized comment field is created in a manner similar to how it can be added for the client's current equipment, as described above with respect to FIGS. 15-19.

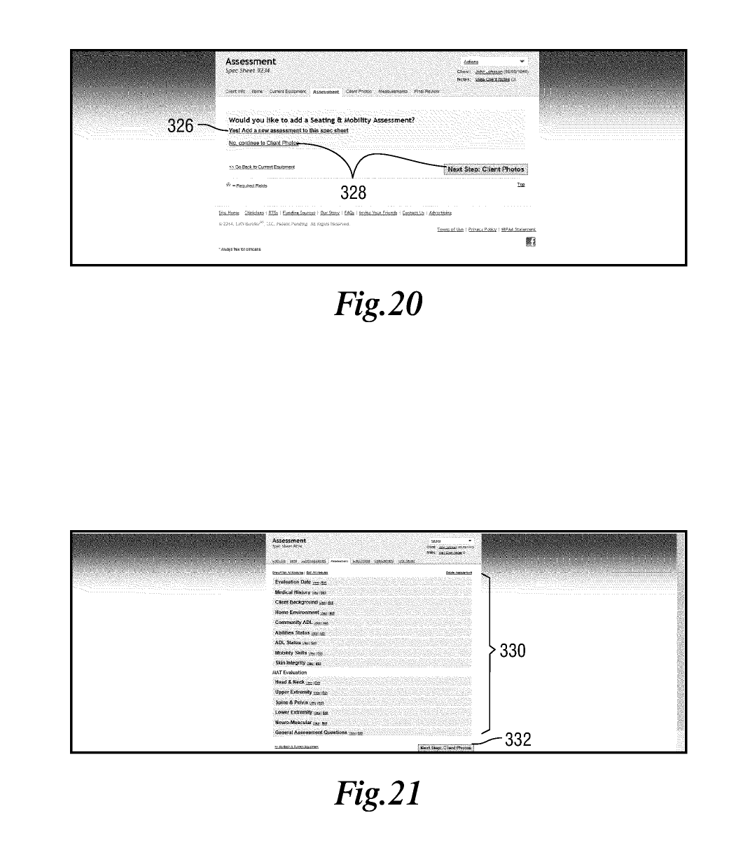

Returning to FIG. 3, the vendor can optionally enter client assessment data 110. FIG. 20 depicts a screenshot where the vendor can choose to enter an optional client seating and mobility assessment 326. Alternatively, in this embodiment, the vendor can skip entering a client seating and mobility assessment and proceed 328 to a client photo interface.

FIG. 21 depicts an interface screen for a vendor to enter client assessment data for a variety of assessment fields 330. When the vendor is done with the client assessment interface, they can send an input 332 to proceed to a client photo interface.

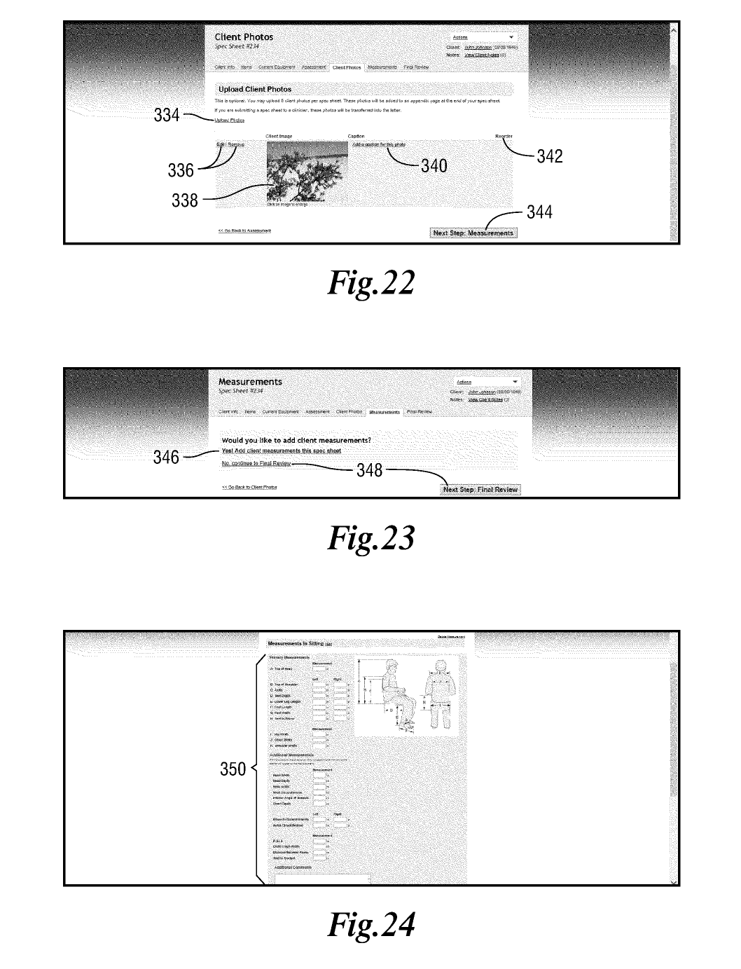

Returning to FIG. 3, the vendor can optionally upload client photos 112. FIG. 22 depicts a screenshot of a client photo interface. The vendor can upload photos 334, edit/remove 336 photos, add an optional caption 340 for each photo, and reorder 342 the listing of photos. Any suitable interface for actually uploading photos, and browsing for photos, can be utilized, as would readily be apparent to one of skill in the art. Moreover, the photo interface can permit any camera-type device to capture an image for use in this client photo interface. Further still, there is no restriction in this embodiment on the content, format, memory size, or pixel size, although other embodiments can have such restrictions. In this embodiment, when the vendor is ready, they can specify a completion input 344 to proceed to an optional ‘client measurements in sitting’ interface.

Returning to FIG. 3, the vendor can optionally enter client measurements 114. FIG. 23 depicts a screenshot wherein the vendor can choose to enter 346 an optional ‘client measurements in sitting’ interface. Alternatively, in this embodiment, the vendor can skip 348 entering the client seating and mobility assessment and proceed in 348 to a spec sheet final review.

FIG. 24 depicts an interface screen for a vendor to enter data in fields pertaining to ‘client measurements in sitting.’ client assessment data for a variety of assessment fields 350. When the vendor is done with the client assessment interface, they can send an input (not shown) to proceed to a spec sheet final review.

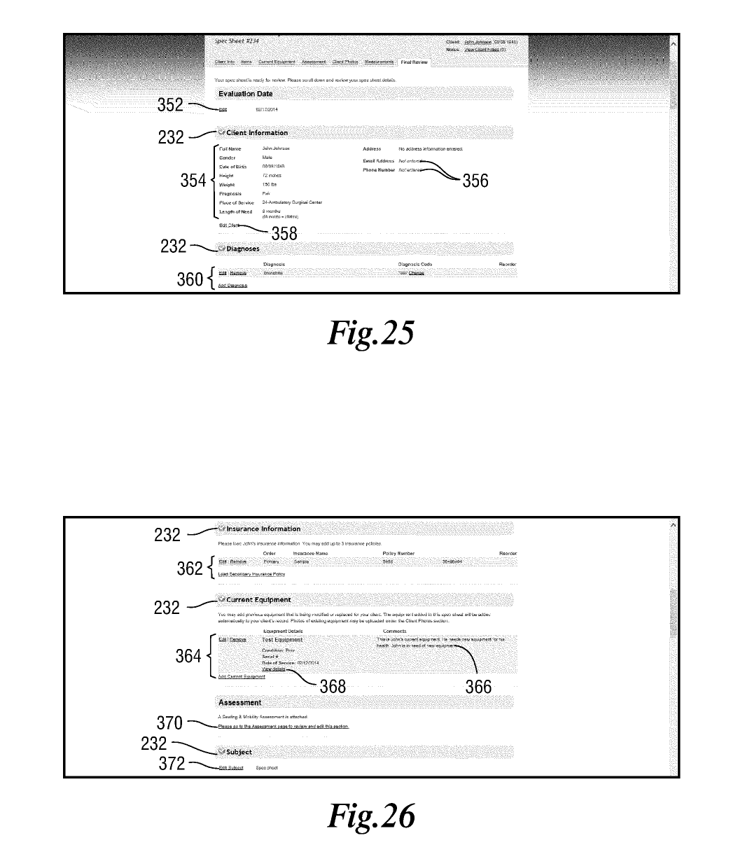

Returning to FIG. 3, the vendor is presented with a final review of the spec sheet 116. FIGS. 25-30 depict an interface for the vendor to perform this review of the spec sheet data. In FIG. 25 the final review provides an evaluation date edit option 352, along with client information 354. Additionally, completion icons 232 are visible as check-marks, meaning that in this embodiment, the fields associated with the completion icons 232 are ready for submission. Further, in this embodiment, at least the ‘Client Information’ field grouping initially displays an icon to indicate that the ‘Client Information’ must be validated/reviewed prior to submission. Some embodiments can require that all fields be validated/reviewed, whereas other embodiments may not require any validation/review. Client Information 354 can display whether certain fields are still blank 356, wherein the interface may or may not require such fields be filled out prior to spec sheet submission. Moreover, in some embodiments, data-type and/or range-checking can be utilized to further restrict vendor input. In some embodiments, even where the information for a field is already present, the vendor can be required to confirm that the information is correct prior to completing the spec sheet final review. The vendor can edit the client information 358. Further, the final review presents an interface to add/edit/remove diagnoses and optional diagnosis codes. Further, the final review allows the vendor to re-order the sequence of diagnoses, which can be accomplished by drag/drop, clicking arrows, or any other suitable way.

FIG. 26 continues with an embodiment of the spec sheet final review providing insurance add/edit/remove options 362. The interface provides further provides current equipment add/edit/remove options 364, and can display the contents a customizable comment field 366 that may or may not have been generated based upon a textual template. The vendor can also request a current equipment detailed view 368. The interface further provides client assessment add/edit/remove options 370. The vendor is also presented spec sheet subject add/edit/remove options 372. The spec sheet subject can be generated with a customized text field as discussed above, but need not be.

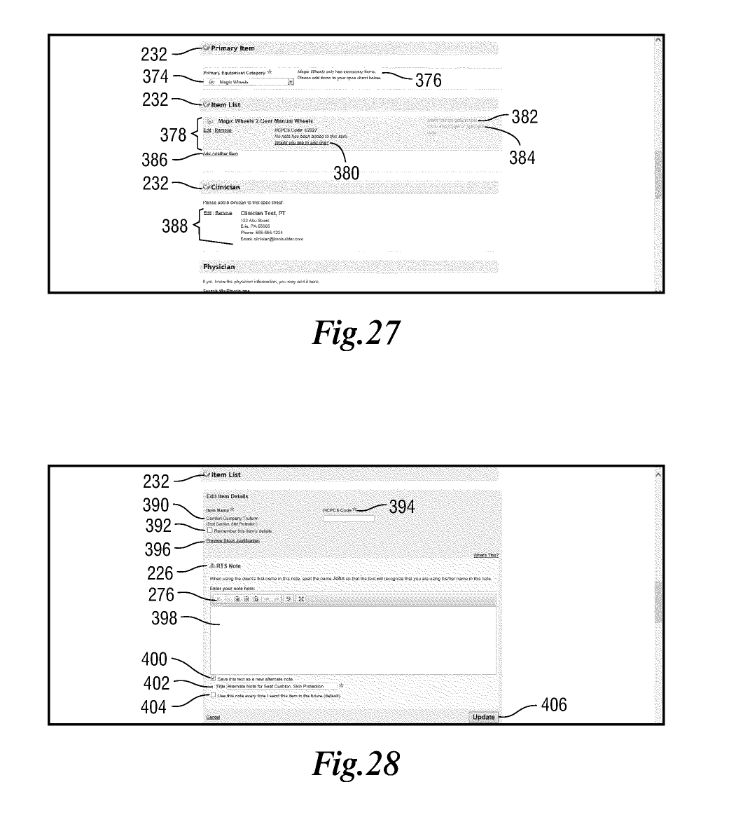

FIG. 27 continues with the present embodiment of the spec sheet final review provides a selectable primary equipment category 374 and primary equipment notations 376. Here, the notations 376 state that the primary equipment category (here a brand) only has equipment accessories, and that vendor needs to specify a primary equipment item. The interface also provides equipment item list interface options 378 to add/edit/remove equipment items and accessories, which can include the primary equipment item. For a note associated with a primary item, the vendor can designate it 382 as a default note. Alternatively, the vendor can be presented the option to copy and modify 384 an alternate note. Here, because the selected equipment item does not have a note associated with it, the interface provides the vendor with the option to add a note 386. Other embodiments can also utilize a plurality of primary equipment items. In this embodiment, the order of equipment items can be re-sequenced in a manner similar to other re-sequencing opportunities for other data, as discussed above. The spec sheet final review also presents clinician edit/remove options 388, along with a display of the designated clinician's information. In other embodiments, any number of clinicians can be used.

FIG. 28 continues with the present embodiment of the spec sheet final review by depicting a screenshot where the vendor has chosen to add a note to the equipment item, as provided by element 386 in FIG. 27. Here, the equipment item name and details 390 for the equipment item are presented, along with an option to remember the equipment item's details 392 for future re-use. The interface also presents a field to add/edit an identifier 394, such as an HCPCS code discussed above. Additionally, the vendor can select a stock justification 396 associated with the equipment item, if available. In some embodiments, the vendor may be required to modify the stock justification prior to spec sheet submission to the clinician's account.

The vendor can also enter an equipment item note 398 for the clinician. Returning to FIG. 3, a customized comment field 108 can be utilized here. As shown in FIG. 28, the equipment item note 398 can utilize the customized comment field template-based text generation format as described above. The vendor can save 400 the equipment item note 398 as a new alternate note. If the vendor chooses this option, they will need to provide a title 402 for the note so it can be found for future use, such as with the same equipment item or for the same clinician. The vendor can also designate the current equipment item note 398 as the default note 404 associated with the equipment item. After the vendor updates 406 the equipment item, the interface returns to the final spec sheet review, wherein the updated information is displayed as depicted in element 364 of FIG. 26.

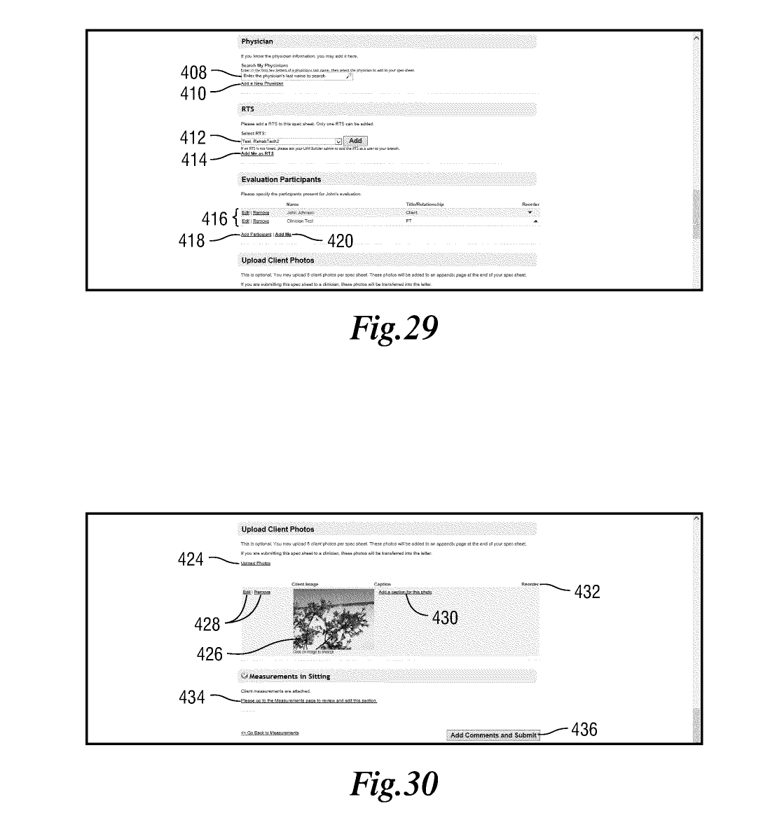

FIG. 29 continues with the present embodiment of the spec sheet final review by providing editable physician information (not shown), if previously provided by the vendor. The vendor can perform a physician search 408 and also manually add 410 a new physician. Additionally, the spec sheet final review displays RTS vendor information (not shown), if previously provided by the vendor. The vendor can perform an RTS vendor search 412 and also add themselves 414 as RTS vendor. The spec sheet final review displays information regarding the client evaluation participants, wherein participants can be edited/removed 416, as well as added 418. Additionally, the vendor can add themselves 420 as an evaluation participant. Further, the vendor can re-sequence 422 the order of evaluation participants, which can be accomplished by drag/drop, clicking arrows, or any other suitable way.

FIG. 30 continues with the spec sheet final review by providing a client photo review. Here the vendor can upload photos 424, which returns the vendor to the photo upload interface disclosed in FIG. 22. Although the present embodiment restricts vendors to six photos per spec sheet, other embodiments have no such restrictions on the number of photos per spec sheet. The interface displays any photos already uploaded 426, along with options to edit/remove 428 each uploaded photo. The vendor can also add a caption 430 to each photo, and re-order a plurality of photos, which can be accomplished by drag/drop, clicking arrows, or any other suitable way. The interface further provides the vendor with the option to add/edit/remove client ‘Measurements in Sitting’ which, in this embodiment, returns the vendor to interface depicted in FIG. 24. When all the completion icons 232 indicate each form item passes its validation check, the interface provides the vendor with the option to add comments and then submit 436.

Returning to FIG. 3, the vendor inputs 118 the date that clinician must finish the LMN, and can request that the clinician perform client assessment and/or measurements of the client. FIG. 31 shows a screenshot of an interface for the vendor to input metadata regarding the spec sheet after the vendor has completed the spec sheet final review (depicted in FIGS. 25-30). The clinician's information 438, which can include name and email address, is presented for final verification. In some embodiments, this information can be edited on this interface screen. This information needs a final verification because this is the email address to which the spec sheet will be sent. The interface also presents an editable date of completion 440, which is the date by which the vendor requests and/or requires that the clinician complete their LMN. This date can also be referred to as a GIDB™ (Get It Done By) date, an LMN due date, or any other suitable description. The interface for selecting this date can utilize any suitable date-entry interface, such as 218 FIG. 7 depicted and discussed above. In some embodiments, the vendor can also request that the clinician perform a client assessment 442 and/or obtain client measurements 444 to accompany the spec sheet. In this embodiment the vendor is required to add spec sheet comments 446, although this can be optional in other embodiments. Returning to FIG. 3, a customized comment field 108 can be utilized here, as explained above with respect to FIGS. 15-19. Returning to FIG. 31, the vendor can then enter an input to submit the spec sheet 448 to the specified clinician's account via email. In other embodiments, the vendor can utilize other options such as downloading the spec sheet, for example, wherein the vendor can submit the spec sheet to the specified vendor by any appropriate means such as mail or fax. In other embodiments, once the vendor completes the spec sheet, the clinician's account receives a notification, and the spec sheet data is automatically imported into the clinician's account for LMN creation purposes. Returning to FIG. 3, the vendor can then submit (or re-submit) 120 the spec sheet, which can include sending the spec sheet to the clinician's account via email, fax, mail, or in any other appropriate way. As shown in FIG. 31, for example, the vendor can click a submit button 448 to send the spec sheet to the clinician.

FIG. 32 depicts a confirmation screen that can be presented to the vendor after successful completion/submission of the spec sheet. The interface can present the vendor with a confirmation message 450 to indicate the successful spec sheet completion. The interface can also present a spec sheet download option 452 and an option to view the vendor's spec sheets 454. Additionally, the interface can allow the vendor to change the spec sheet's status or date needed 456. The interface can also provide options for the vendor to discuss 458 the spec sheet with the clinician, and to also send a reminder 460 to the clinician's account about the spec sheet.

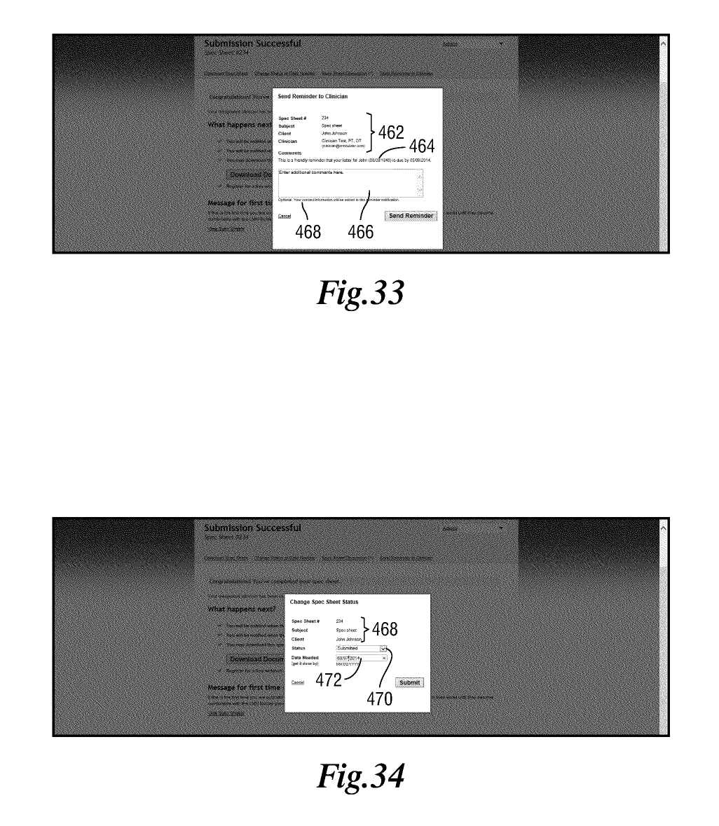

Returning to FIG. 3, after submission of the spec sheet to the clinician's account, the vendor can send updates 122 that can include, for example, messages, status change indication (such as ‘In-Progress,’ ‘Submitted,’ and/or ‘Completed’). FIG. 33 shows a screenshot of an exemplary interface for the vendor to send a reminder to a clinician's account regarding a spec sheet. The reminder can utilize basic information 462 that includes, but is not limited to, a spec sheet number (which in some embodiments can be a unique identifier), a reminder subject, the client's name, and the clinician's name and email address. The reminder can also include a pre-generated comment 464 that can include, for example, the client's name and the GIDB. The reminder can also utilize comment text 466, which can be text directly entered by the vendor. In other embodiments, this comment text 466 can be in the form of a customized comment field discussed above with respect to FIGS. 15-19. The vendor's contact information can optionally be added 468 to the reminder as well.

FIG. 34 is a screenshot depicting a vendor changing a spec sheet's status. This interface can include pre-populated data 468, for example spec sheet number, a subject, and the client's name. The vendor can also modify the spec sheet status 470. In this embodiment, the options can include, for example, ‘Submitted,’ ‘In Progress,’ ‘Completed,’ and ‘Printed for Fax.’ Other embodiments can include any type of status. The interface further provides an option to modify the LMN due date 472. The interface for selecting this date can utilize any suitable date-entry interface, such as 218 FIG. 7 depicted and discussed above.

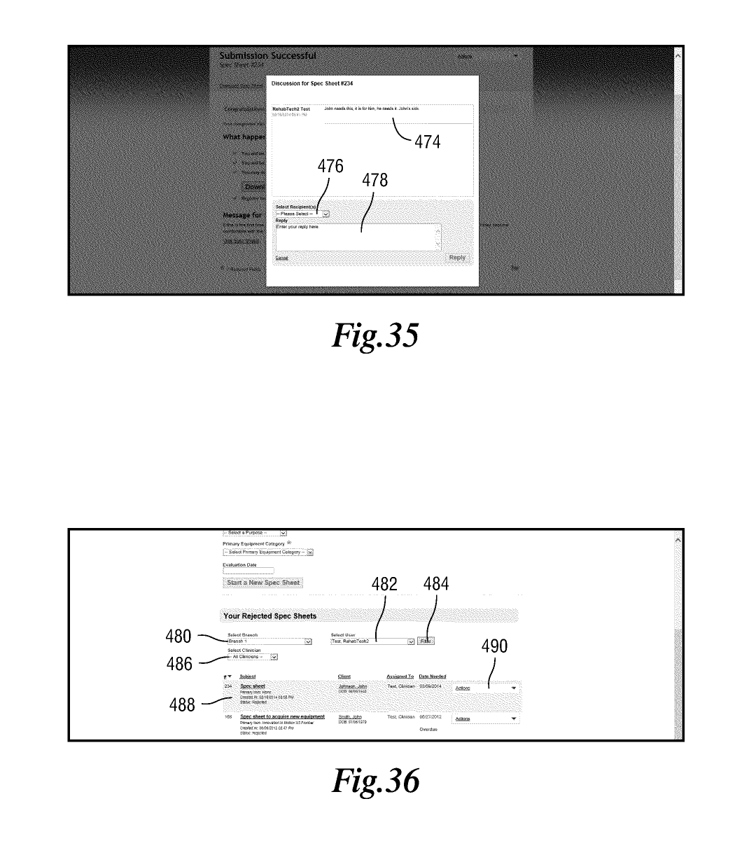

FIG. 35 is a screenshot depicting a vendor sending a discussion communication regarding the spec sheet. This discussion interface can display some or all of the previous communications 474 related to the spec sheet. This list of previous discussions 474 can take the form of a discussion thread or any other suitable interface, including expandable/collapsible, hyperlinks, date-stamps, etc. The interface also provides an option to select a recipient 476, which in this embodiment would include the clinician. Other embodiments can include options for pre-selected parties based upon data associated with the spec sheet, and/or an option to enter information for a new recipient. The discussion interface can also utilize comment text 478, which can be text directly entered by the vendor. In other embodiments, this comment text 478 can be in the form of a customized comment field discussed above with respect to FIGS. 15-19.

Returning to FIG. 3, if in 124 a rejection of the spec sheet is received from the clinician's account, then in 126 the vendor is notified of the rejection of the spec sheet, and is presented with comments received from the clinician's account (if any). FIG. 36 depicts a screenshot of an interface for a vendor to review spec sheets that have been rejected. In some embodiments, the interface can be directed to all in-progress spec sheets, all accepted spec sheets, or any other type of reporting with respect to spec sheets. The vendor can select a branch office location 480, which can include any number of branches, and which in this embodiment corresponds to the vendor's office location. In other embodiments, the branch can correspond to the clinician's branch office location. The interface can also permit the vendor to select a vendor account 482, which in this embodiment includes other users in the vendor's office that may have their own, related accounts. In other embodiments, a vendor may be restricted to only their account. The vendor can choose to filter 484 spec sheets by either or both of these criteria, although other embodiments can use any other appropriate filtering options. The interface also provides an option to select spec sheets by clinician 486. In this embodiment, each spec sheet record 488 displays a title, primary item, creation date/time, status, client name and birthdate, to whom the spec sheet was assigned, the LMN due date, and actions 490. These actions 490, in this embodiment, can include (for example) options to ‘Continue this spec sheet,’ ‘Review/edit,’ and ‘Delete this spec sheet.’ Other embodiments can include other options. In this embodiment, the spec sheet records can be sorted by any available criteria, and the number of records available on-screen can be customized so that records that exceed a specified number per-page can be displayed on subsequent pages.

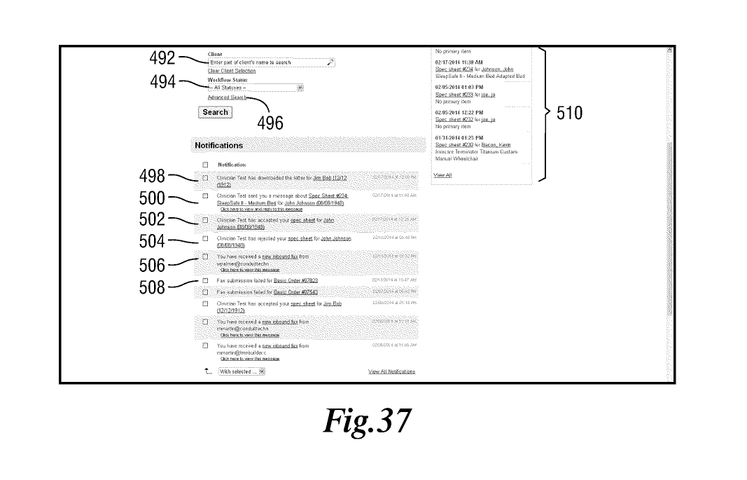

Returning to FIG. 3, if in 124 an acceptance of the spec sheet is received from the clinician's account, then in 128 the vendor is notified of the acceptance. Further, the vendor is also notified again in 128 when there is a completed LMN from the clinician's account that is associated with the spec sheet. FIG. 37 is a screenshot of an interface where the vendor receives notifications regarding spec sheets. The vendor can search for spec sheets utilizing a client's name 492 and/or the workflow status of a spec sheet 494, which in this embodiment can include, for example, ‘In Progress,’ ‘Cancelled,’ ‘Completed,’ and ‘Overdue.’ Advanced search features 496 can include searching by clinician, physician, branch office location, and/or vendors/users associated with the vendor's account. The interface can display spec sheet notifications that include, for example: when an LMN has been downloaded by a clinician's account 498, when a message has been received from a clinician's account 500, when a clinician's account has accepted a spec sheet 502, when a clinician's account has rejected a spec sheet 504, when a new fax has been received 506, and/or when a fax submission has failed 508. The interface can also display the most recent spec sheet notifications 510 for spec sheets that have been, for example, updated and/or have an associated status update.

The clinician role will now be discussed in detail. Referring back to FIG. 2, a clinician can log into their online clinician account in any manner consistent with that described above with respect to a vendor logging into their online vendor account.

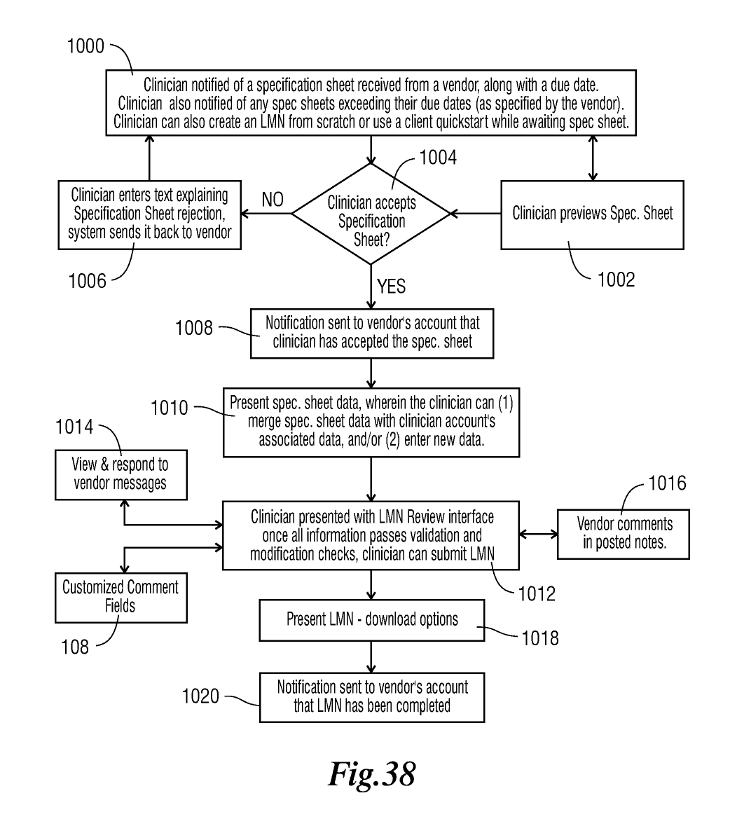

FIG. 38 depicts a flow chart disclosing the generation of an LMN. In 1000, the clinician's account is notified of when a specification sheet is received from a vendor's account, along with a due date for the LMN. The clinician's account is also notified of any spec sheets exceeding their due dates (as specified by the associated vendor's account). The clinician can also create an LMN from scratch or use a client quickstart while awaiting a spec sheet for that client.

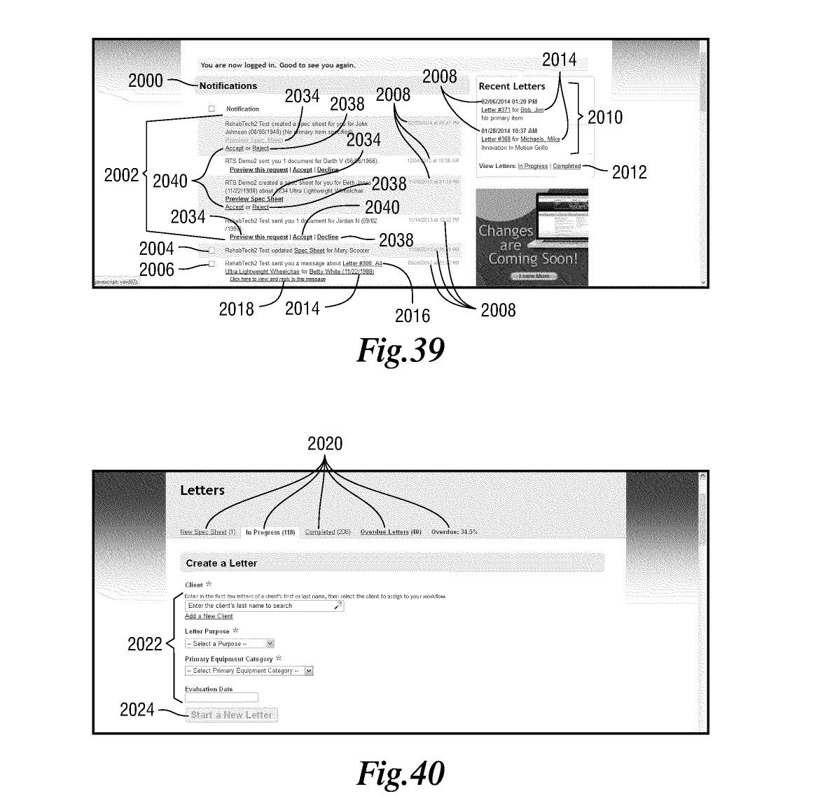

An exemplary interface is depicted in FIG. 39, where the clinician's account can display notifications 2000 that can include, for example, new spec sheets received from vendor accounts 2002, spec sheets that have been updated by vendor accounts 2004, messages from vendor accounts associated with spec sheets 2006, and a timestamp 2008 for each notification 2000. The interface can also display indications of the most recently completed LMN's 2010 associated with the clinician account. The interface can also sort and/or selectively display LMN's that are classified according to criteria 2012 such as ‘in progress’ and ‘completed.’ The interface can also allow the clinician to select a client name 2014 where all LMN's associated with the client can be displayed. The interface can also allow the clinician to select a particular LMN 2016. The interface may also present a vendor discussion indication 2018 associated with an LMN, which will be discussed in more detail below with respect to FIG. 49.

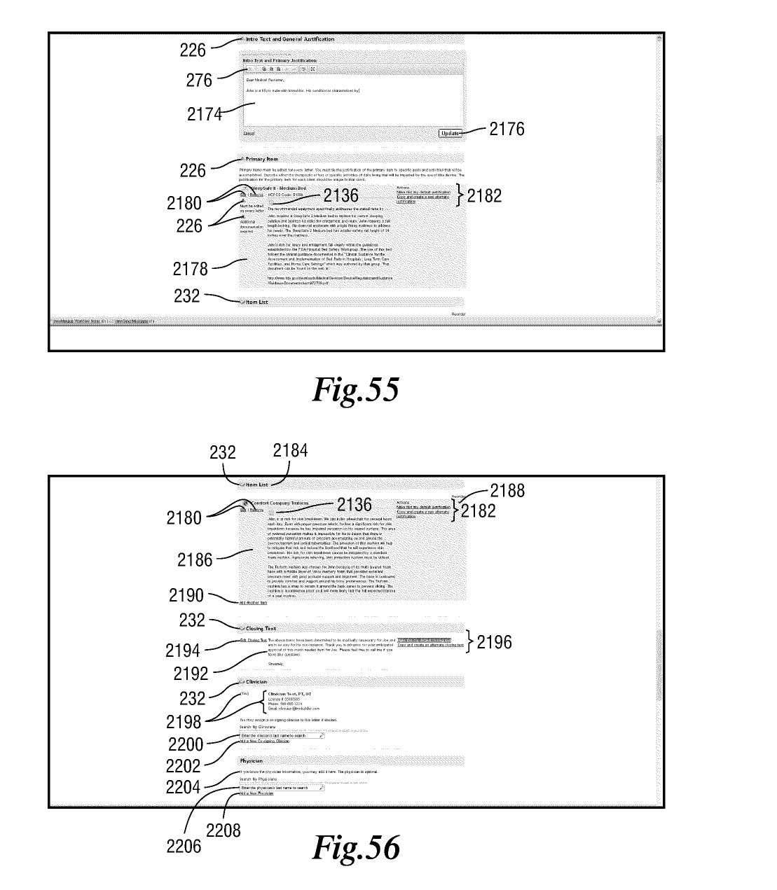

In FIG. 40, the interface can also present information reporting options 2020. For example, LMN's can be viewed and/or grouped according to criteria such as: new spec sheets, in-progress LMN's, completed LMN's, and/or overdue LMN's (exceeding their due dates). Additionally, information such as quantity per criterion and the percentage of LMN's that are overdue can also be displayed. In other embodiments, the information reporting options 2020 can omitted or presented with only some of these options described. In one embodiment, if a clinician desires or needs to manually create an LMN without pre-populated data, the clinician enters client information 2022 that parallels the options discussed above with respect to FIG. 4 for spec sheet creation by a vendor. The clinician can confirm 2024 this information and proceed in creating a new LMN without an associated spec sheet. In one embodiment, the clinician inputs information in a manner parallel to that where a vendor enters information for a spec sheet up until final review. In this embodiment, there are additional interfaces for a justification and for resources that correspond to associated interfaces in the final review. These additional interfaces are discussed below with respect to FIGS. 54-55 for adding a justification and FIGS. 47 and 58 for adding a resource. In other embodiments, other types of interfaces can be utilized.

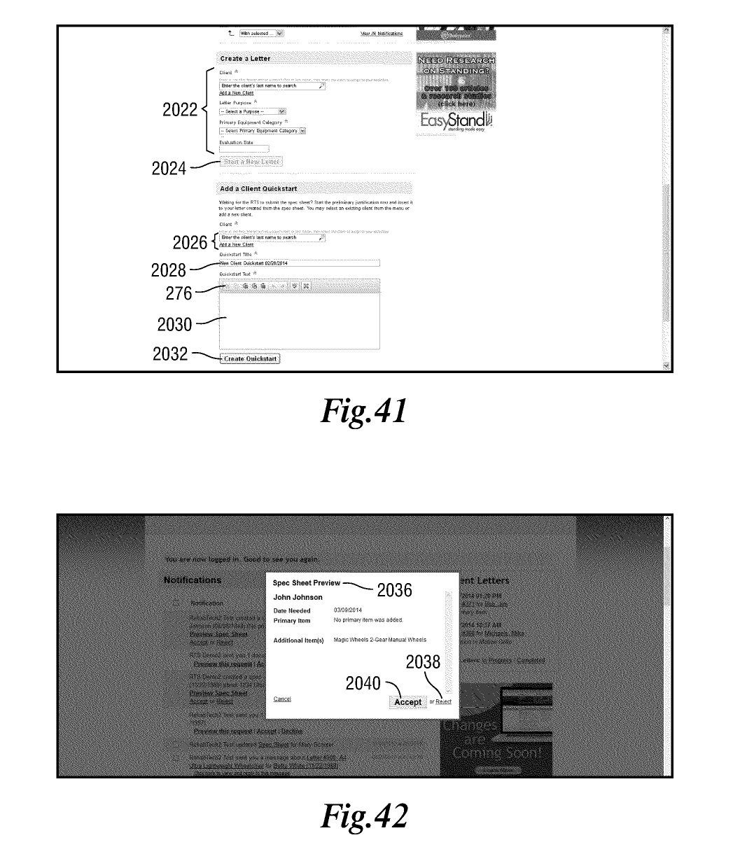

FIG. 41 depicts a quickstart interface where a clinician can begin an LMN while still waiting on a spec sheet from the associated vendor. The clinician specifies a client 2026 either by searching the client records associated with their clinician account or by creating a new client record. The clinician creates a quickstart title 2028 and associated justification text 2030, which can be utilized in some embodiments as a customized comment field that is utilized in a manner as described above with respect to FIGS. 15-19. The clinician can confirm quickstart creation by utilizing an input 2032.

Returning to FIG. 39, options for new spec sheets 2002 can include previewing a spec sheet 2034, rejecting (or declining) a spec sheet 2038, and accepting a spec sheet 2040. Referring back to FIG. 38, the clinician can also choose a spec sheet preview 1002. FIG. 42 depicts an example of a spec sheet preview 2030, which can include the client's name, the date by which the LMN is needed, a primary item (if available), and additional items. This example of a spec sheet preview can also utilize reject 2032 and accept 2034 options that correspond to those discussed above for FIG. 39.

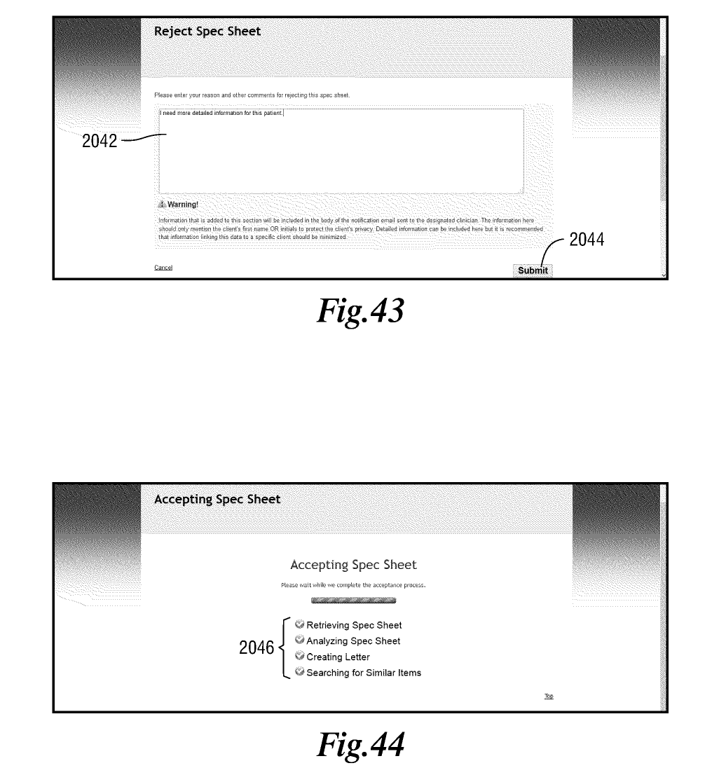

Returning to FIG. 38, if the clinician rejects the spec sheet in 1004 (as shown in 2038 of FIGS. 39 and 42), then in 1006 the clinician can enter text explaining the rejection to the associated vendor. An exemplary interface is depicted in FIG. 43, where the clinician can enter text 2042 explaining the rejection/decline, and input a confirmation 2044. In some embodiments, the text 2042 can utilize a customized comment field as described above with respect to FIGS. 15-19. The rejection/decline confirmation 2044 can result in the spec sheet rejection/decline being sent to the vendor's account, as depicted in 1006 of FIG. 38 and can correspond to 126 of FIG. 3 which depicts the vendor's account receiving the corresponding rejection/decline. A rejection/decline can also correspond to a status update in the associated vendor's account, as previously described for 504 in FIG. 37.

Returning to FIG. 38, if the clinician accepts the spec sheet in 1004 (as shown in 2040 of FIGS. 39 and 42), then an interface screen such as FIG. 44 can be utilized to provide notifications 2046 regarding how the spec sheet is being processed. This can result in the spec sheet acceptance being sent to the vendor's account, as depicted in 1008 of FIG. 38. This can also correspond to 128 of FIG. 3, which depicts the vendor's account receiving a corresponding acceptance notification. An acceptance can also correspond to a status update in the associated vendor's account, as previously described for 502 in FIG. 37.

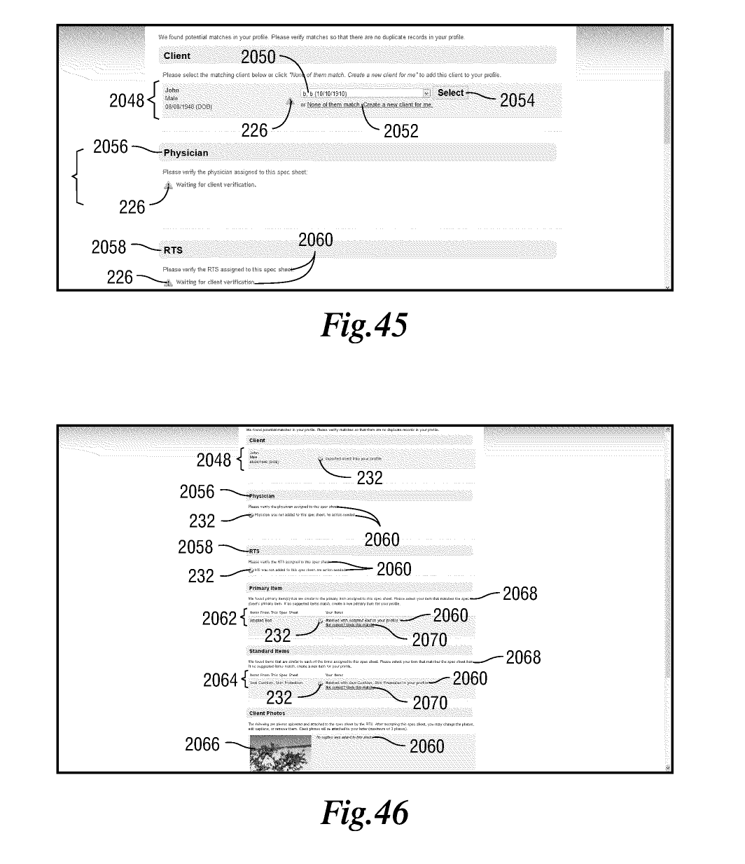

Referring back to FIG. 38, embodiments of the interface import data from the spec sheet in 1010. As depicted in a sample importation interface in FIG. 45, client data 2048 can be imported from the spec sheet and displayed in the clinician's account for verification. The interface can utilize the imported client data 2048 for comparison with client records associated with the clinician's account 2050. If the clinician does not find a suitable match within their client records 2050 for the imported client data 2048, they can alternatively enter a new client record 2052. Creating a new client record 2052 can be accomplished using the interface described above with respect to FIG. 40 or any other suitable interface. In this embodiment, until the clinician completes 2054 the client information, the interface can prevent the display of additional imported spec sheet data, such as physician data 2056 and/or RTS vendor data 2058. Other embodiments may not utilize such restrictions. The interface can utilize an alert icon 226 as discussed above with respect to FIG. 8, or any other suitable icon. The client data alert icon 226 in FIG. 45 indicates that the client data has not been completed. Alert icons 226 for physician data 2056 and RTS vendor data 2058 are each accompanied by explanatory text 2060 explaining that the client data must be completed first, for example.

FIG. 46 depicts a screenshot of the same importation interface with completed client information 2048. The interface can utilize, for example, completion icons 232 as discussed above with respect to FIG. 10, along with accompanying explanatory text 2060. Here the interface displays completion icons 232 for client information 2048, physician data 2056, RTS vendor data 2058, primary item data 2062, and standard items data 2064. The interface can also display client photos 2066 imported from the spec sheet along with explanatory text 2060, stating (for example) that there is no caption associated with a photo. The interface can provide matching feedback 2068 indicating that a match from the spec sheet was found, and is presented for inspection. The interface can further provide an undo match option 2070, where the clinician can indicate that they do not want to use the suggested match that corresponds to data imported from the spec sheet.

FIG. 47 continues with the importation interface where available resources 2072 can be utilized. Resources can refer, for example, to medical and/or research-related websites. Resources can provide scientific and/or medical evidence as part of an item's justification in an LMN. In some embodiments, resources can be rated (not shown) among clinician accounts, vendor accounts, or both. These ratings allow collaborative commentary regarding resources, and can function as a type of peer review and/or crowd-sourced resource rating/commentary. Resource ratings can take the form of numerical scores, a quantity of stars, a ranking of available resources, or any other suitable type of rating system. Resources can be associated with diagnoses and/or equipment items so that they can be suggested automatically. The interface can provide an item name list 2074 for available resources that match diagnosis data and items from the spec sheet or are already associated with the LMN. The interface can also display a message 2076 if no matching available resources have been found.

Continuing with FIG. 47, the interface presents a resource creation section 2078 where the clinician can add one or more resources 2080 to the LMN. The clinician can input a resource title 2082, a resource URL 2084, and may be presented with an option to test 2086 the resource URL 2084 to verify its validity and/or view the website to which it refers. The interface can also accept text 2088 regarding a resource, which be implemented as a customized comment field, described above with respect to FIGS. 15-19. When adding a new resource, the interface can incorporate LMN diagnoses 2090 where the interface may display selectable diagnoses 2092, which can be based on their association with other data in the clinician's account, such as items. The interface can also incorporate LMN items 2094 where the interface may display selectable items 2096. The interface can also set forth required fields rules 2098 that can apply to any interface in various embodiments, such as all fields being required unless noted as optional. The interface can also utilize rules that indicate whether diagnoses 2092 and/or items 2096 are selected by default, not selected by default, or which ones are selected by default. The clinician indicates when the new resource is complete 2100, and can re-order/re-sequence 2102 a plurality of resources. When the importation interface (depicted in FIGS. 45-47) is completed 2104, the clinician is presented with an LMN final review interface, as shown in 1012 of FIG. 38.

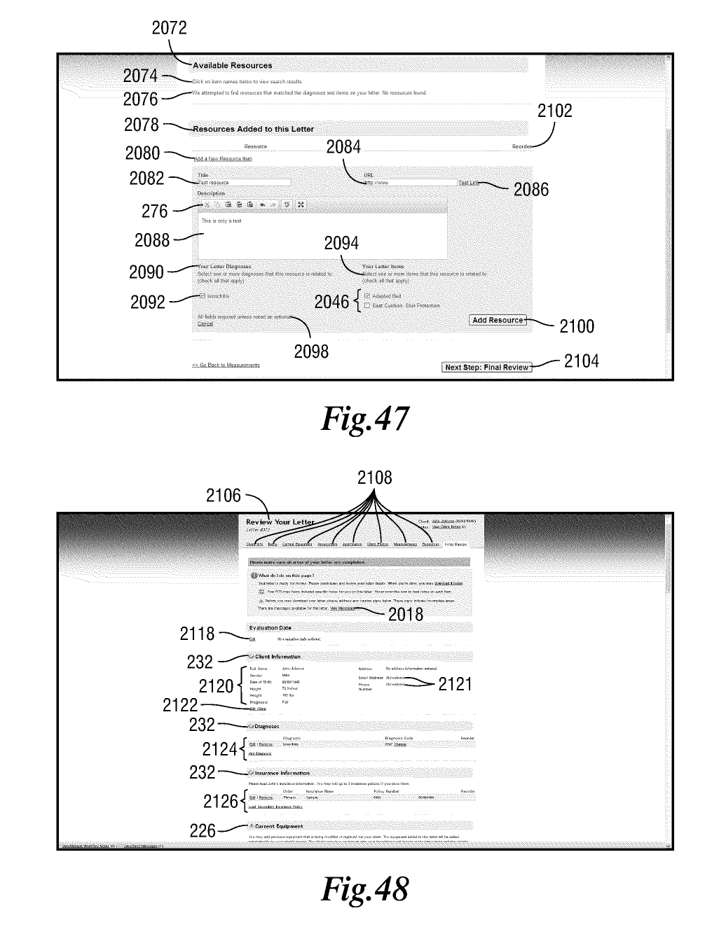

FIG. 48 depicts an embodiment of an LMN final review interface 2106. Similar to the tabs 222 depicted above in FIG. 8 in an embodiment of the spec sheet creation interface, the LMN final review interface 2106 can display selectable tabs 2108 (or any other appropriate selectable option) that can correspond to the field grouping described below within the LMN final review interface 2106.

Returning to FIG. 38, the clinician account's may receive vendor comments 1014 as described above, which can correspond to 122 of FIG. 3 and the interface discussed above with respect to FIG. 35. Embodiments may utilize may utilize a vendor message indication 2018, as depicted in FIGS. 39 and 48, for example. Acknowledging the indication 2018 can bring up an interface screen such as that depicted in FIG. 49, which displays of the messages 2110 between the clinician and the vendor associated with the LMN and its related spec sheet, respectively. The clinician can send a message to any selectable recipient 2112, which can include the vendor that sent the spec sheet, although other recipients are possible as well. Reply text 2114 can be entered, and may utilize a customized comment field, as described above with respect to FIGS. 15-19. When the reply message is complete, the clinician may submit 2116 it.

Referring back to FIG. 38, after the clinician has sent a message 1014, the interface can return to the LMN final review interface in 1012 shown in FIG. 48. After the clinician has sent a message 1014, the interface returns to the LMN final review interface in 1012. The status of an individual field can cause an entire field grouping, such as ‘Client Information’ to display an alert icon 226, for example, or prevent the vendor from advancing from the current interface screen, as a type of form-validation, for example. Completion icons 232 are also visible (here as check-marks), meaning that in this embodiment, the fields bearing the completion icons 232 are ready for submission. Further, in this embodiment, at least the ‘Client Information’ field grouping initially displays an icon to indicate that the ‘Client Information’ must be validated/reviewed prior to submission. Some embodiments can require that all fields be validated/reviewed, whereas other embodiments may not require any validation/review.

The LMN final review interface 2106 in FIG. 48 can display an editable evaluation date 2118 imported from the spec sheet. The LMN final review interface 2106 can also display some or all of the client data 2116, whether or not such data was imported from a spec sheet. Individual fields such as client height, weight, email address, and phone number, as shown, can display a status 2121 such as ‘Please validate’ or ‘not entered,’ for example. If the clinician edits the client information 2122, the interface can utilize a client information screen as shown in FIG. 9, for example. The LMN final review interface 2106 can also display diagnoses 2124 imported from the spec sheet, with the ability to edit/delete such diagnoses and/or add a new diagnosis. The LMN final review interface 2106 can further display client insurance information 2126 imported from the spec sheet, with the ability to edit/delete such insurance policies and/or add a new insurance policy.

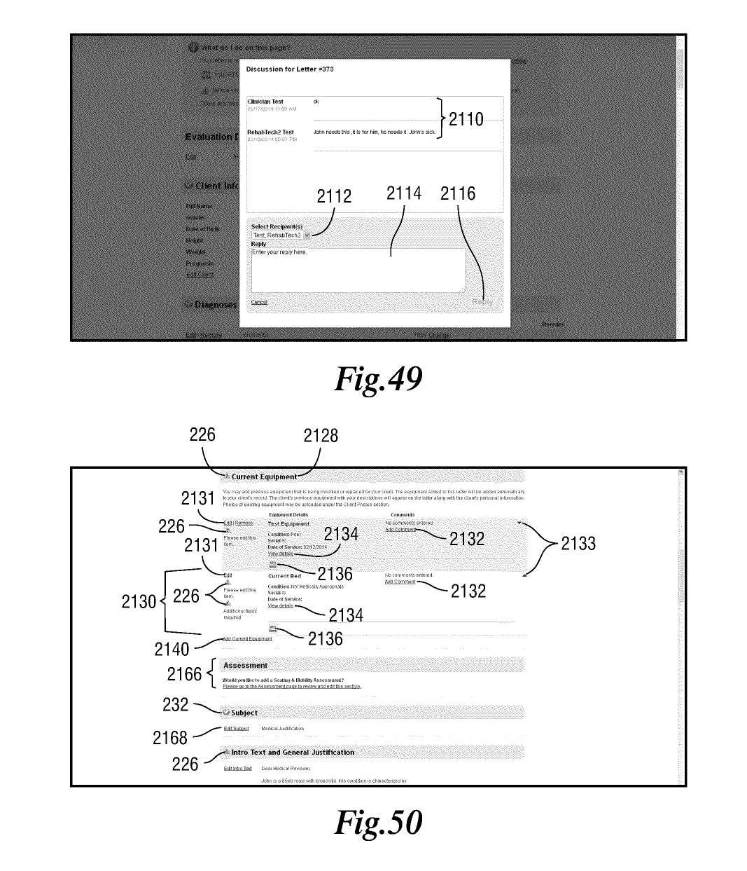

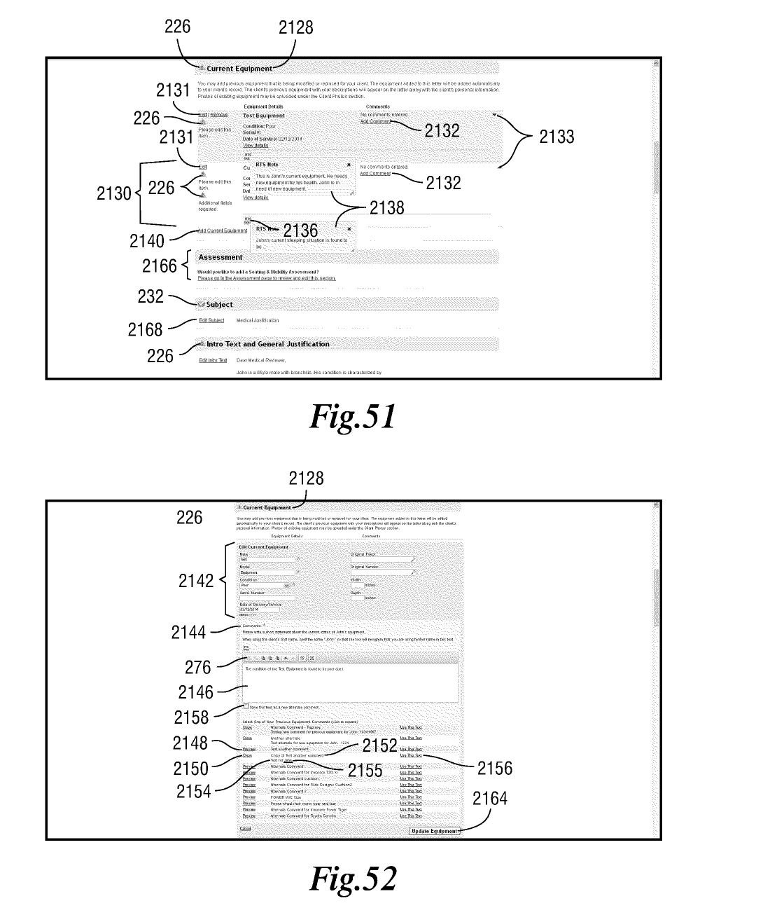

The instant depiction of the LMN final review interface 2106 continues in FIG. 50. The clinician can review/edit current equipment 2128 from the spec sheet. The current equipment items 2130 can be displayed to the clinician, with the option to add clinician comments 2132 to each current equipment item 2130. Each current equipment item can be modified 2131 and/or removed. The sequence/order of current equipment items can be modified 2133 as well. The clinician can also view more current equipment item details 2134. Additionally, the clinician can activate the vendor's posted-note comment indicators 2136 that are also associated with a particular current equipment item 2130, as imported from the spec sheet. FIG. 51 depicts an example of vendor comment posted-notes 2138 that can be displayed when the clinician selects a vendor's posted-note comment indicator 2136 depicted in FIG. 50. This posted-note data can correspond to the vendor comments entered in 398 of FIG. 28, as previously discussed above. For the current equipment 2128 shown in FIGS. 50-51, the clinician can also add additional current equipment items 2140, regardless of whether there were already current equipment items 2130 imported from the spec sheet.

If the clinician utilizes a current equipment item edit option 2131 as shown in FIGS. 50-51, a current equipment item editing interface 2128 can be displayed, as shown in FIG. 52. Editable current equipment item information 2142 includes, for example, the current equipment's make, model, condition, serial number, date of delivery/service, original payor, original vendor, and/or the equipment's height/width. Additionally, the vendor can be presented with an editable customized comment field 2146. The interface can present any number of text editing options 276 for any textual field described herein, as described above with respect to FIG. 16, for example. Further, text editing options 276 can be presented as icons, or as any other type of suitable selectable options, and can include, for example: cut, copy, paste, paste as plain text, text color, text size, subscript, superscript, paste from another program such as WORD®, font, special characters, paste with source formatting, paste with destination formatting, paste with mixed formatting, undo, redo, spell-check, bold, italicize, underline, strike-through, highlighting, bullet-points, line spacing, text justification/alignment, text tables, and/or field enlargement.

Continuing with the embodiment disclosed in FIG. 52, text entered into the comment field 2146 can be parsed in real-time, periodically, or based upon input received from the vendor to indicate that the text is ready to be parsed and/or saved. Parsing is performed when creating a template version of the text within the comment text field 2146. Parsing and text replacement is explained in greater detail above with respect to FIGS. 16-19. If the clinician selects a preview option 2148 to preview template text, the vendor can view how the template text will appear with the current client's information applied. At any time the clinician can choose a ‘close’ option 2150 to hide or collapse the preview text. Here the clinician has chosen to preview template text 2148 titled ‘Copy of Test another comment’ 2152, which causes the interface to display a modified template 2154 that utilizes the current client's name 2155, John. In this embodiment, the vendor can have as many template previews 1254 open as desired, although the number of preview templates open simultaneously can be restricted in other embodiments. Here, the template preview text applies the current client's name by utilizing a name placeholder (not shown) for the client name. For example, the last word in this modified template utilizes the current client's name of ‘John’ 2155 where a name placeholder had been utilized. The name ‘John’ 2155 is displayed in the location within the text where a name placeholder was located. In this embodiment the interface presents a ‘Use This Text’ 2156 option, which places the textual template in the comment field 2154. Multiple textual templates can be placed in the comment field 2146 in this way.

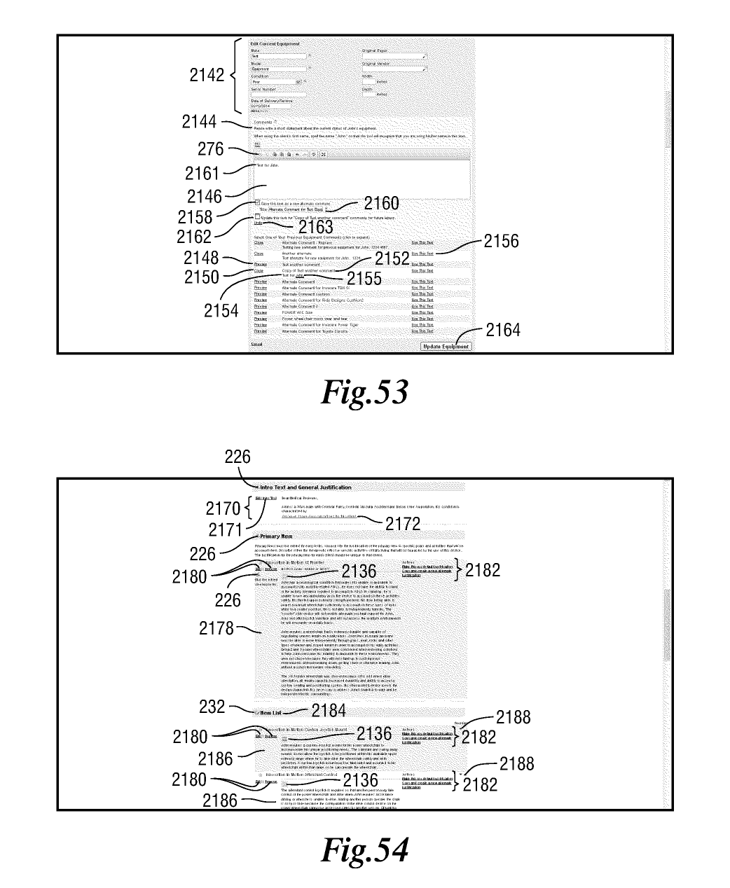

FIG. 53 continues with the current embodiment, where the clinician has clicked the ‘Use This Text’ option 2156. As a result, the comment field 2146 now displays updated comment field text 2161 that corresponds to the template text 2154 that was selected. Regardless of whether the clinician uses template text or writes entirely new text, there is a template save option 2158 which can cause a title field 2160 to appear, where the clinician can then input a title for this comment field text 2146. If the clinician selects the option to save this updated comment field text 2161 as a template, placeholders (as described above, not shown) will be placed in the specific locations of the text they replace, if and/or where appropriate. Additionally, the clinician can also choose an option to update the text of the currently selected template 2162 for future LMN's. The clinician can utilize an undo option 2163 to roll back the textual changes, or utilize a completion input 2164 upon completing the text for the current equipment item.

Returning to FIG. 50, the LMN final review interface 2106 can also display a client assessment 2166 imported from the spec sheet, if available from the vendor (as discussed above with respect to FIG. 21). The clinician can edit/delete a client assessment 2166 imported from the spec sheet, or add their own client assessment. In some embodiments this may open the client assessment interface indicated (for example) that can also be reached by the tabs 2108 shown in FIG. 48. The assessment interface can resemble that discussed above with respect to FIG. 21. Continuing with FIG. 50, the clinician can input an LMN subject 2168 from scratch, which can also be edited, deleted, and/or imported from the spec sheet.

FIG. 54 continues with the LMN final review interface 2106. In the current embodiment, the clinician must enter intro text and a general justification 2170 for the LMN, where some/all text can be pre-generated for the clinician, and is editable. The clinician can edit 2171 the intro text and general justification. In the instant embodiment, editing the text is required, whereas such editing/modification may not be required in other embodiments. The clinician is also presented with an option to select from other narratives previously utilized for the client 2172 (if any), based upon previous LMN's that the clinician may have generated for the particular client. Previous client narratives 2172 can be utilized, in some embodiments, as a customized comment field that is utilized in a manner as described above with respect to FIGS. 15-19 and/or 52-53. In this embodiment, the intro text and general justification 2170 are required and the LMN final review cannot be completed without modifying the intro text and general justification text 2170.

If the clinician selects an edit option 2171 for the intro text and general justification, FIG. 55 depicts this edit interface in the LMN final review interface 2106. The clinician can edit the contents of the text field 2174, and indicate completion 2176, for example, by selecting an ‘Update’ button.

Returning to FIG. 54, the LMN final review interface 2106 can also include a primary item 2178, whose text can be required to be different for each LMN. This can be accomplished, for example, with edit/remove options 2180. The primary item can also utilize actions 2182 to (1) make the current primary item justification the new default justification and/or (2) copy and create a new alternate justification (template). In some embodiments, the primary item justification can be implemented as a customized comment field that is utilized in a manner as described above with respect to FIGS. 15-19 and/or 52-53. The primary item 2178 can also utilize a posted note 2136 to display vendor comments, as discussed above with respect to FIGS. 50-51.

Continuing with FIG. 54, the LMN final review interface 2106 can also include an item list 2184, which can include equipment items imported from the spec sheet. Each equipment item 2186 can include edit/remove options 2180 as well as actions 2182 to (1) make the current primary item justification the new default justification for the item and/or (2) copy and create a new alternate justification (template) for the item. In some embodiments, the primary item justification can be implemented as a customized comment field that is utilized in a manner as described above with respect to FIGS. 15-19 and/or 52-53. Each item 2186 can also utilize a posted note 2136 to display vendor comments, as discussed above with respect to FIGS. 50-51. Additionally, items 2186 can be reordered 2188 by the clinician utilizing arrows (as shown) or any other suitable re-ordering interface. The clinician can also add additional items (as shown in 2190 of FIG. 56).

FIG. 56 continues with the instant embodiment of the LMN final review interface 2106. The interface requires closing text 2192, although other embodiments can render this optional. The clinician is presented with a closing text editing option 2194, which can utilize a customized comment in a manner as described above with respect to FIGS. 15-19 and/or 52-53. There are also actions 2196 to (1) make the current closing text the new default closing text and/or (2) copy and create new closing text.

The clinician is also presented with options regarding clinician selection for the LMN. In the instant embodiment the clinician designated in the spec sheet by the vendor is imported, wherein the clinician's account is the default clinician listed 2198. Other clinicians may be listed by default in other embodiments. The clinician can add a co-signing clinician to the LMN, either by searching for clinicians 2200 associated with the clinician's account and/or the patient record, or by adding a new co-signing clinician 2202.

The clinician is further presented with physician information 2204, which is optional in this embodiment, but may be required in other embodiments. The clinician can add a physician to the LMN by either searching for physicians 2206 associated with the clinician's account and/or the patient record, or by creating a new physician 2208.

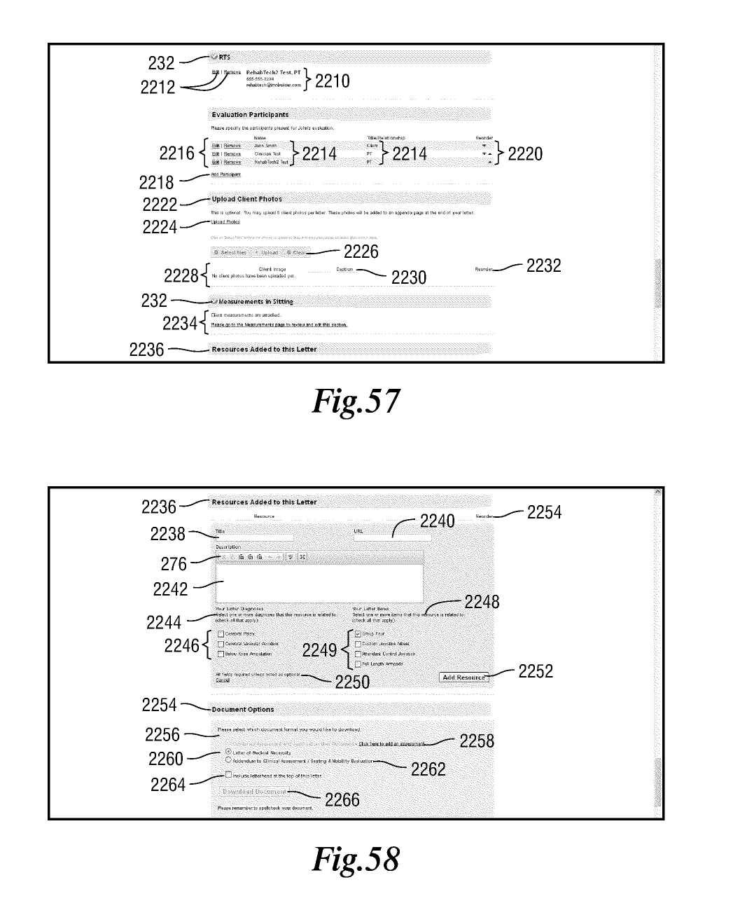

Continuing with the LMN final review interface 2106, in FIG. 57 the clinician is further presented with RTS vendor information 2210 that is imported from the spec sheet. The RTS information is required in this embodiment but may be optional in other embodiments. By default, the RTS vendor information matches the vendor whose account created the spec sheet, but this information can be edited and/or deleted 2212. In other embodiments, RTS vendor information may not be modifiable.

The clinician also manages the client evaluation participant list 2214, which is required in this embodiment, but may be optional in other embodiments. The list includes identifying information 2214 that can include the names and titles/roles of evaluation participants. The clinician can edit/remove 2216 participants as well as add a participant 2218. Additionally, the clinician can change the order/sequence 2220 of the participants.

Continuing with the embodiment in FIG. 57, the clinician can manage client photos 2222, which are optional in this embodiment, but can be required in other embodiments. The clinician can upload photos 2224 utilizing any suitable photo uploading interface, which may (but not necessarily) be an interface similar to those discussed above with respect to FIGS. 22 and 30. Photos (not shown) have options 2226 that can include, for example, selecting individual or groups of photos, uploading one or more photos at once, clearing the selection(s) of one or more photos, and/or the option to delete one or more photos (not shown). The photos can be displayed 2228 along with their associated captions 2230, which are optional in the present embodiment, but can be required in other embodiments. Photos can also be re-ordered/re-sequenced 2232 by the clinician.

The clinician can also add/edit/remove client sitting measurements 2234, which can be imported with a spec sheet, if they were previously taken by the associated vendor. Alternatively, the clinician can input client sitting measurements 2234, even if they were already included in an imported spec sheet. In any event, client sitting measurements are optional in this embodiment, but can be required in other embodiments. Accessing the client measurements 2234 in this embodiment opens an interface similar to that disclosed above with respect to FIG. 24.

In FIG. 58, the clinician is presented with a resource creation/review interface 2236, where the clinician can add/edit/delete one or more resources (not shown) to the LMN. The clinician can input a resource title 2238, a resource URL 2240, and may be presented with an option to test (not shown) the resource URL 2240 to verify its validity and/or view the website to which it refers. The interface can also accept text 2242 regarding a resource, which can utilize a customized comment field, as described above with respect to FIGS. 15-19 and 52-53. When adding a new resource, the interface can incorporate LMN diagnoses 2244 where the interface may display selectable diagnoses 2246, which can be based on their association with other data in the clinician's account, such as items. The interface can also incorporate LMN items 2248 where the interface may display selectable items 2249. The interface can also set forth required fields rules 2250 that can apply to any interface in various embodiments, such as all fields being required unless noted as optional. The interface can also utilize rules that indicate whether diagnoses 2246 and/or items 2249 are selected by default, not selected by default, or even which ones are selected by default. The clinician indicates when the new resource is complete 2252, and can re-order 2254 the listing for a plurality of resources.

Continuing with the embodiment presented in FIG. 58, the clinician is further provided document options 2254. In this embodiment, the clinician chooses an option from among a plurality of options. The first option, which is not selectable in this embodiment unless a client assessment has been performed, is a document format that includes a client assessment and a justification 2256. If a client assessment has not been performed, then an option to add a client assessment 2258 can be selected in some embodiments. Another selectable document option 2254 is for an LMN 2260. The third option shown here is for an addendum to a clinical assessment/seating & mobility evaluation 2262. In other embodiments, other suitable options can be presented, and multiple document options 2254 may be selectable. In this embodiment, there is also a selectable letterhead option 2264 to include letterhead regardless of the document option 2254 selected. Other embodiments restrict the letterhead option 2264 to only certain document options 2254. Once all required field groupings have been validated (such as with a completion icon 232 and/or the absence of alert icons 226), a download document 2266 option will be selectable. In other embodiments, the download document 2266 is optional and/or always selectable without any data validation.

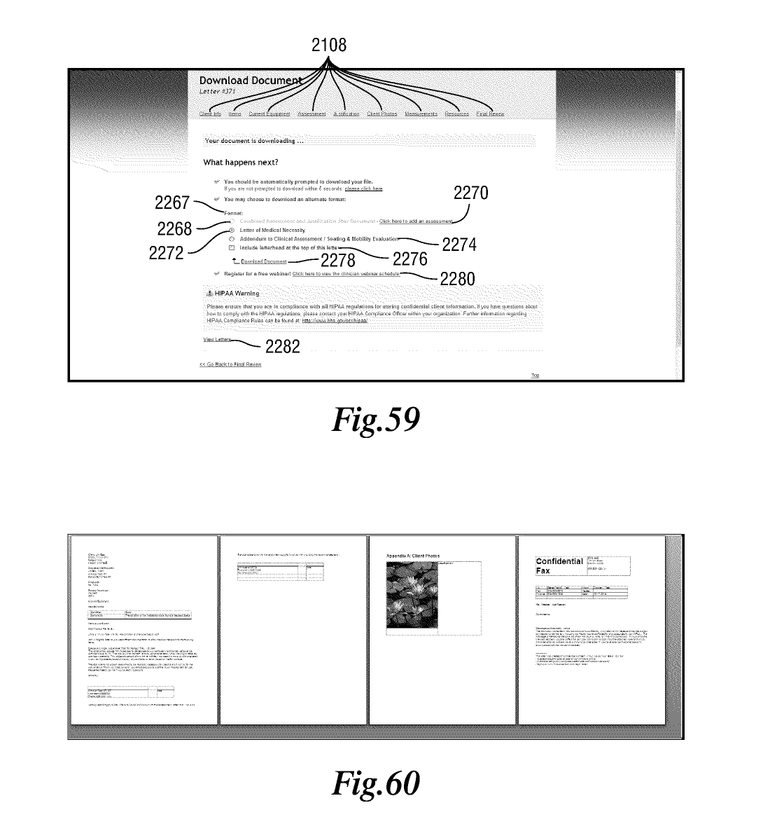

Returning to FIG. 38, after the clinician completes the LMN final review and submits the LMN in 1012, they are presented with a download interface in 1018. FIG. 59 depicts a document download interface. The clinician is provided with document download options 2267. In this embodiment, the clinician chooses an option from among a plurality of options. The first option, which is not selectable in this embodiment unless a client assessment has been performed, is a document format that includes a client assessment and a justification 2268. If a client assessment has not been performed, then an option to add a client assessment 2270 can be selected in some embodiments. Another selectable document option 2267 is for an LMN 2272. The third option shown here is for an addendum to clinical assessment/seating & mobility evaluation 2274. In other embodiments, other suitable options can be presented, and multiple document download options 2267 may be selectable. In this embodiment, there is also a selectable letterhead option 2276 to include letterhead regardless of the document option 2267 selected. Other embodiments restrict the letterhead option 2276 to only certain document options 2267. In other embodiments, one of the document download options 2267 can be pre-selected based upon the choice selected in FIG. 58 for the document options 2254. In some embodiments, the clinician may be presented with either the document options 2254 depicted in FIG. 58 or the document download options 2267 depicted in FIG. 59 (instead of both), or neither.

Continuing with FIG. 59, the clinician can input a download document request 2278 to complete the LMN. In this embodiment, the clinician can also elect to view webinar schedules 2280 that may be specific to the clinician or apply generally to all clinician-type accounts. The clinician can also view their existing LMN's 2282, which can include the current letter after performing the document download 2278.

FIG. 60 depicts a sample LMN/document after the clinician has performed a document download in 2278 of FIG. 59. The LMN/document can be in any suitable electronic file format, and can be printed out in hardcopy form and/or faxed, either electronically or as a hard copy. Additionally, in this embodiment, after the clinician has performed an LMN/document download in 2278 of FIG. 59, the vendor's account receives a notification of the LMN/document download, as shown in 1020 of FIG. 38. This further corresponds to the vendor account notification shown in 498 of FIG. 37, as well condition 2 “clinician completes LMN” in 128 of FIG. 3.

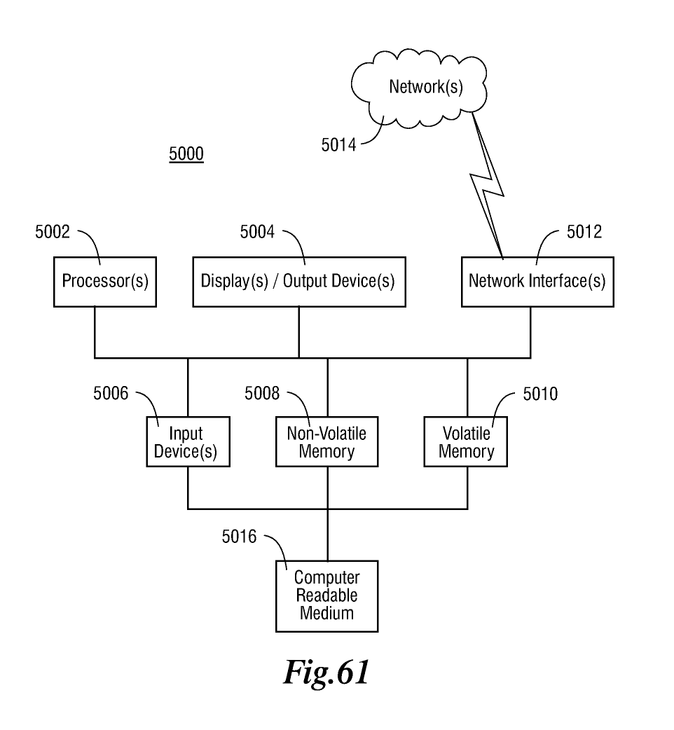

FIG. 61 illustrates an exemplary computer system 5000, through which embodiments of the disclosure can be implemented. The system 5000 described herein is but one example of a suitable computing environment and does not suggest any limitation on the scope of any embodiments presented. Nothing illustrated or described with respect to the system 5000 should be interpreted as being required or as creating any type of dependency with respect to any element or plurality of elements. In a basic embodiment, the system 5000 often includes at least one processor 5002 and memory (non-volatile memory 5008 and/or volatile memory 5010). The system 5000 can include one or more displays and/or output devices 5004 such as monitors, speakers, headphones, projectors, wearable-displays, holographic displays, and/or printers, for example. The system 5000 may further include one or more input devices 5006 which can include, by way of example, any type of mouse, keyboard, disk/media drive, memory stick/thumb-drive, memory card, pen, touch-input device, biometric scanner, voice/auditory input device, camera, etc. The system 5000 typically includes non-volatile memory 5008 (ROM, flash memory, etc.), volatile memory 5010 (RAM, etc.), or a combination thereof. The system 5000 can include one or more network interfaces 5012 to facilitate communication between the system 5000 and one or more additional devices, which may include, for example, client and/or server devices. A network interface 5012 can facilitate communications over a network 5014 that may include any suitable type of public or private network, which by non-limiting example can include the internet, wireless networks, PAN, LAN, WAN, MAN, telephone networks, cable networks, fiber-optic networks, cellular networks, and/or satellite networks. All aforementioned devices, systems, connections, and/or accessories do not warrant further discussion as they are readily understood within the art.

A computer-readable medium 5016 may comprise a plurality of computer readable mediums, each of which may be either a computer readable storage medium or a computer readable signal medium. A computer readable storage medium 5016 may reside, for example, within an input device 5006, non-volatile memory 5008, volatile memory 5010, or any combination thereof. A computer readable storage medium can include tangible media that is able to store instructions associated with, or used by, a device or system. A computer readable storage medium includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium may also include, for example, a system or device that is of a magnetic, optical, semiconductor, or electronic type.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A computer-implemented method for generating a specification sheet through an interface that utilizes a display device, comprising:
receiving a specification sheet creation request from a vendor;
receiving a data item comprising client name and gender, a clinician, and a vendor, wherein the interface provides a vendor self-selection option;
presenting, through the interface, selection options for an equipment purpose and a primary equipment category comprising manufacturers, general equipment types, and a no-primary item option;
receiving vendor input that selects the equipment purpose and primary equipment;
providing a final review with options to add, edit, and delete a data item that requires vendor input indicating validation of the data item;
receiving vendor input that specifies, for the specification sheet, a customized comment field and a letter of medical necessity completion deadline;
subsequently presenting through the interface the clinician's response to the specification sheet, that indicates acceptance or rejection requiring resubmission;
after receiving acceptance through a network from the clinician, the interface sends a completion notification once the clinician has completed a letter of medical necessity that imports data items from the specification sheet; and
wherein each customized comment field comprises:
creating, prior to starting the instant specification sheet, a comment template based on an earlier specification sheet by:
identifying, within textual input associated with the prior specification sheet, each matching instance corresponding to data-types comprising: a prior person's name, possessive versions of the prior person's name, and gender-specific pronouns matching the prior person's gender; and
replacing each matching instance with a placeholder corresponding to its matching data-type; and
outputting, on the display device, the comment template by replacing each data-type placeholder with corresponding client data from the instant specification sheet.

2. The computer-implemented method in claim 1 wherein the interface provides, for specification sheets associated with the vendor's account, a listing of the most recent specification sheets and searching for existing specification sheets by client name, specification sheet status, clinician, and physician.

3. The computer-implemented method in claim 1 wherein the equipment purpose further comprises:
presenting the vendor with selectable choices comprising:
acquiring new equipment;
replacing existing equipment; and
modifying existing equipment;
wherein if the vendor selects modifying or replacing existing equipment, the vendor is subsequently prompted to input information about the client's current equipment, and a customized comment field for client's current equipment.

4. The computer-implemented method in claim 1 wherein after receiving vendor input specifying completion of the final review, the interface provides options for the vendor to request client measurements, an assessment, or both, from the clinician.

5. The computer-implemented method in claim 1 wherein the interface presents an option to input, edit, and delete a data item comprising a client assessment.

6. The computer-implemented method in claim 1 wherein the interface presents a photo uploading option for a data item, wherein if input is received to upload photos, the interface receives text from the vendor associated with uploaded photos.

7. The computer-implemented method in claim 1 wherein the interface presents an option to input, edit, and delete a data item comprising client measurements.

8. The computer-implemented method in claim 1 wherein the interface sends the clinician, based on vendor input, a deadline reminder or deadline modification.

9. The computer-implemented method in claim 1 wherein after a specification sheet rejection from the clinician, the interface presents clinician comments and editable specification sheet data, and in response receives specification sheet resubmission from the vendor.

10. The computer-implemented method in claim 1 wherein a specification sheet data item comprises client information, a client evaluation date, and a primary item category comprising: a manufacturer, an equipment-type, or an accessories-only category.

11. The computer-implemented method in claim 1 wherein a data item contains client information comprising client insurance information, client diagnosis, participants in a client evaluation whose sequence in the client evaluation is editable, and a physician, wherein the interface provides physician information retrieval from separate software when requested by the vendor.

12. The computer-implemented method in claim 1 wherein the interface further comprises presenting options to request that the clinician perform a client assessment, client measurements, or both.

13. The computer-implemented method in claim 1 wherein, for the primary equipment category in a data item:
if a manufacturer selection is received, presenting equipment models corresponding to the selected manufacturer, or indicating that the selected manufacturer only has accessory items; and
if a general equipment type selection is received, presenting equipment-type choices based upon the general equipment type, an option to create a new primary item, and a model number field or choices based upon the general equipment type entered, wherein if an option to create a new primary item selection is received, then the interface presents input fields for equipment type and model number; and
presenting a customized comment field and selectable item accessory choices, searchable by name or code, organized according to accessory categories corresponding to the primary item, with an option to create a new accessory item, wherein each choice can be added or removed as a favorite, wherein if an option to create a new accessory item is received, then the interface presents fields for accessory name, code, category, and model.

14. The computer-implemented method in claim 1 wherein if the equipment purpose in a data item is equipment replacement or modification, the interface presents options to add additional current equipment, remove current equipment, and modify information regarding current equipment, comprising make, model, condition, client's current condition with respect to the current equipment, current equipment risk factors that are selectable or creatable, and a customized comment field.

15. The computer-implemented method in claim 1 wherein the interface provides status updates for specification sheets associated with the vendor's account.

16. The computer-implemented method in claim 1 wherein the customized comment field further comprises:
presenting the vendor with selectable comment templates that the vendor can preview or place within a text field in the customized comment field; and
presenting the vendor with selectable options to:
save text within the text field as a new comment template; and
update the currently selected comment template with the text currently in the text field.

17. The computer-implemented method in claim 1 wherein the interface provides stock justification text for vendor-selected equipment.

18. A non-transitory computer-readable medium for generating a specification sheet through an interface containing instructions that, when executed by a processor, cause the processor to perform a method comprising:
receiving a specification sheet creation request from a vendor;
receiving a data item comprising client name and gender, a clinician, and a vendor, wherein the interface provides a vendor self-selection option;
presenting, through the interface, selection options for an equipment purpose and a primary equipment category comprising manufacturers, general equipment types, and a no-primary item option;
receiving vendor input that selects the equipment purpose and primary equipment;
providing a final review with options to add, edit, and delete a data item that requires vendor input indicating validation of the data item;
receiving vendor input that specifies, for the specification sheet, a customized comment field and a letter of medical necessity completion deadline;
subsequently presenting through the interface the clinician's response to the specification sheet, that indicates acceptance or rejection requiring resubmission;
after receiving acceptance through a network from the clinician, the interface sends a completion notification once the clinician has completed a letter of medical necessity that imports data items from the specification sheet; and
wherein each customized comment field comprises:
creating, prior to starting the instant specification sheet, a comment template based on an earlier specification sheet by:
identifying, within textual input associated with the prior specification sheet, each matching instance corresponding to data-types comprising: a prior person's name, possessive versions of the prior person's name, and gender-specific pronouns matching the prior person's gender; and
replacing each matching instance with a placeholder corresponding to its matching data-type; and
outputting, on the display device, the comment template by replacing each data-type placeholder with corresponding client data from the instant specification sheet.

19. The non-transitory computer-readable medium in claim 18 wherein the interface provides, for specification sheets associated with the vendor's account, a listing of the most recent specification sheets and searching for existing specification sheets by client name, specification sheet status, clinician, and physician.

20. The non-transitory computer-readable medium in claim 18 wherein the equipment purpose further comprises:
presenting the vendor with selectable choices comprising:
acquiring new equipment;
replacing existing equipment; and
modifying existing equipment;
wherein if the vendor selects modifying or replacing existing equipment, the vendor is subsequently prompted to input information about the client's current equipment, and a customized comment field for client's current equipment.

21. The non-transitory computer-readable medium in claim 18 wherein after receiving vendor input specifying completion of the final review, the interface provides options for the vendor to request client measurements, an assessment, or both, from the clinician.

22. The non-transitory computer-readable medium in claim 18 wherein the interface presents an option to input, edit, and delete a data item comprising a client assessment.

23. The non-transitory computer-readable medium in claim 18 wherein the interface presents a photo uploading option for a data item, wherein if input is received to upload photos, the interface receives text from the vendor associated with uploaded photos.

24. The non-transitory computer-readable medium in claim 18 wherein the interface presents an option to input, edit, and delete a data item comprising client measurements.

25. The non-transitory computer-readable medium in claim 18 wherein the interface sends the clinician, based on vendor input, a deadline reminder or deadline modification.

26. The non-transitory computer-readable medium in claim 18 wherein after a specification sheet rejection from the clinician, the interface presents clinician comments and editable specification sheet data, and in response receives specification sheet resubmission from the vendor.

27. The non-transitory computer-readable medium in claim 18 wherein a specification sheet data item comprises client information, a client evaluation date, and a primary item category comprising: a manufacturer, an equipment-type, or an accessories-only category.

28. The non-transitory computer-readable medium in claim 18 wherein a data item contains client information comprising client insurance information, client diagnosis, participants in a client evaluation whose sequence in the client evaluation is editable, and a physician, wherein the interface provides physician information retrieval from separate software when requested by the vendor.

29. The non-transitory computer-readable medium in claim 18 wherein the interface further comprises presenting options to request that the clinician perform a client assessment, client measurements, or both.

30. The non-transitory computer-readable medium in claim 18 wherein, for the primary equipment category in a data item:
if a manufacturer selection is received, presenting equipment models corresponding to the selected manufacturer, or indicating that the selected manufacturer only has accessory items; and
if a general equipment type selection is received, presenting equipment-type choices based upon the general equipment type, an option to create a new primary item, and a model number field or choices based upon the general equipment type entered, wherein if an option to create a new primary item selection is received, then the interface presents input fields for equipment type and model number; and
presenting a customized comment field and selectable item accessory choices, searchable by name or code, organized according to accessory categories corresponding to the primary item, with an option to create a new accessory item, wherein each choice can be added or removed as a favorite, wherein if an option to create a new accessory item is received, then the interface presents fields for accessory name, code, category, and model.

31. The non-transitory computer-readable medium in claim 18 wherein if the equipment purpose in a data item is equipment replacement or modification, the interface presents options to add additional current equipment, remove current equipment, and modify information regarding current equipment, comprising make, model, condition, client's current condition with respect to the current equipment, current equipment risk factors that are selectable or creatable, and a customized comment field.

32. The non-transitory computer-readable medium in claim 18 wherein the interface provides status updates for specification sheets associated with the vendor's account.

33. The non-transitory computer-readable medium in claim 18 wherein the customized comment field further comprises:
presenting the vendor with selectable comment templates that the vendor can preview or place within a text field in the customized comment field; and
presenting the vendor with selectable options to:
save text within the text field as a new comment template; and
update the currently selected comment template with the text currently in the text field.

34. The non-transitory computer-readable medium in claim 18 wherein the interface provides stock justification text for vendor-selected equipment.

35. A system for generating a specification sheet comprising:
a memory; and
a processor coupled to said memory, said processor configured to:
receive a specification sheet creation request from a vendor;
receive a data item comprising client name and gender, a clinician, and a vendor, wherein said interface provides a vendor self-selection option;
present, through said interface, selection options for an equipment purpose and a primary equipment category comprising manufacturers, general equipment types, and a no-primary item option;
receive vendor input that selects said equipment purpose and primary equipment;
provide a final review with options to add, edit, and delete a data item that requires vendor input indicating validation of said data item;
receive vendor input that specifies, for said specification sheet, a customized comment field and a letter of medical necessity completion deadline;
subsequently present through said interface a response from the clinician regarding said specification sheet, that indicates acceptance or rejection requiring resubmission;
after receiving acceptance through a network from the clinician, said interface sends a completion notification once the clinician has completed a letter of medical necessity that imports data items from said specification sheet; and
wherein each customized comment field comprises:
creating, prior to starting the instant specification sheet, a comment template based on an earlier specification sheet by:
identifying, within textual input associated with the prior specification sheet, each matching instance corresponding to data-types comprising: a prior person's name, possessive versions of the prior person's name, and gender-specific pronouns matching the prior person's gender; and
replacing each matching instance with a placeholder corresponding to its matching data-type; and
outputting, on the display device, the comment template by replacing each data-type placeholder with corresponding client data from the instant specification sheet.

36. The system in claim 35 wherein said interface provides, for specification sheets associated with said vendor's account, a listing of the most recent specification sheets and searching for existing specification sheets by client name, specification sheet status, clinician, and physician.

37. The system in claim 35 wherein said equipment purpose further comprises:
presenting the vendor with selectable choices comprising:
acquiring new equipment;
replacing existing equipment; and
modifying existing equipment;
wherein if the vendor selects modifying or replacing existing equipment, the vendor is subsequently prompted to input information about said client's current equipment, and a customized comment field for client's current equipment.

38. The system in claim 35 wherein after receiving vendor input specifying completion of said final review, said interface provides options for the vendor to request client measurements, an assessment, or both, from the clinician.

39. The system in claim 35 wherein said interface presents an option to input, edit, and delete a data item comprising a client assessment.

40. The system in claim 35 wherein said interface presents a photo uploading option for a data item, wherein if input is received to upload photos, said interface receives text from the vendor associated with uploaded photos.

41. The system in claim 35 wherein said interface presents an option to input, edit, and delete a data item comprising client measurements.

42. The system in claim 35 wherein said interface sends the clinician, based on vendor input, a deadline reminder or deadline modification.

43. The system in claim 35 wherein after a specification sheet rejection from the clinician, said interface presents clinician comments and editable specification sheet data, and in response receives specification sheet resubmission from the vendor.

44. The system in claim 35 wherein a specification sheet data item comprises client information, a client evaluation date, and a primary item category comprising: a manufacturer, an equipment-type, or an accessories-only category.

45. The system in claim 35 wherein a data item contains client information comprising client insurance information, client diagnosis, participants in a client evaluation whose sequence in said client evaluation is editable, and a physician, wherein said interface provides physician information retrieval from separate software when requested by the vendor.

46. The system in claim 35 wherein said interface further comprises presenting options to request that the clinician perform a client assessment, client measurements, or both.

47. The system in claim 35 wherein, for said primary equipment category in a data item:
if a manufacturer selection is received, presenting equipment models corresponding to said selected manufacturer, or indicating that said selected manufacturer only has accessory items; and
if a general equipment type selection is received, presenting equipment-type choices based upon said general equipment type, an option to create a new primary item, and a model number field or choices based upon said general equipment type entered, wherein if an option to create a new primary item selection is received, then said interface presents input fields for equipment type and model number; and
presenting a customized comment field and selectable item accessory choices, searchable by name or code, organized according to accessory categories corresponding to said primary item, with an option to create a new accessory item, wherein each choice can be added or removed as a favorite, wherein if an option to create a new accessory item is received, then the interface presents fields for accessory name, code, category, and model.

48. The system in claim 35 wherein if said equipment purpose in a data item is equipment replacement or modification, said interface presents options to add additional current equipment, remove current equipment, and modify information regarding current equipment, comprising make, model, condition, client's current condition with respect to said current equipment, current equipment risk factors that are selectable or creatable, and a customized comment field.

49. The system in claim 35 wherein said interface provides status updates for specification sheets associated with said vendor's account.

50. The system in claim 35 wherein said customized comment field further comprises:
presenting the vendor with selectable comment templates that the vendor can preview or place within a text field in said customized comment field; and
presenting the vendor with selectable options to:
save text within said field as a new comment template; and
update the currently selected comment template with said text currently in the text field.

51. The system in claim 35 wherein said interface provides stock justification text for vendor-selected equipment.

52. A computer-implemented method for generating a letter of medical necessity through an interface that utilizes a display device, comprising:
notifying a clinician of a specification sheet from a vendor specifying the clinician and containing a deadline;
receiving a response from the clinician through a network that indicates acceptance or rejection of the specification sheet, wherein the interface sends the response to the vendor;
after receiving an acceptance response from the clinician, the interface presents the clinician with:
potential data item matches from an account associated with the clinician that correspond to a data item type in the specification sheet;
an option to create a data item utilizing a data item of the same data item type from the specification sheet; and
an option to create a data item without specification sheet data;
providing a final review with options to add, edit, and delete a data item that requires clinician input indicating validation of the data item;
providing vendor comments associated with a data item to the clinician, wherein the data item corresponds to a specification sheet data item containing the vendor comments;
presenting the clinician letter of medical necessity download options;
notifying the vendor of the clinician's letter of medical necessity download; and
wherein each customized comment field comprises:
creating, prior to starting the instant letter of medical necessity, a comment template based on an earlier letter of medical necessity by:
identifying, within textual input associated with the prior letter of medical necessity, each matching instance corresponding to data-types comprising: a prior person's name, possessive versions of the prior person's name, and gender-specific pronouns matching the prior person's gender; and
replacing each matching instance with a placeholder corresponding to its matching data-type; and
outputting, on the display device, the comment template by replacing each data-type placeholder with corresponding client data from the instant letter of medical necessity.

53. The computer-implemented method in claim 52 wherein the interface provides the clinician, prior to the response, a selectable preview of the specification sheet.

54. The computer-implemented method in claim 52 upon receiving a rejecting response, the interface:
presents the clinician with a comment field for text to accompany the response; and
requires the vendor to resubmit the specification sheet to the clinician.

55. The computer-implemented method in claim 52 wherein prior to receiving a specification sheet notification, the interface presents an option to the clinician to create preliminary text, for either a new client or an existing client, wherein the preliminary text is added to a letter of medical necessity after acceptance of a specification sheet by the clinician.

56. The computer-implemented method in claim 52 wherein the interface provides the clinician an option to create a letter of medical necessity prior to accepting a specification sheet.

57. The computer-implemented method in claim 52 wherein the interface provides an option to undo an automated match of a data item in the specification sheet with a corresponding item associated with the clinician's account.

58. The computer-implemented method in claim 52 wherein a data item comprises a client, a physician, primary equipment, and a vendor, wherein the interface indicates whether the vendor in the specification sheet matches the vendor that submitted the specification sheet.

59. The computer-implemented method in claim 52 wherein the interface presents optional data items, that if included in the specification sheet, comprise client assessment, client measurements, client photos, and text accompanying the client photos, wherein the interface provides the clinician with an option to input new versions of these data items.

60. The computer-implemented method in claim 52 wherein the interface notifies the clinician of:
a deadline reminder from a vendor;
a deadline modification by a vendor; and
a deadline that exceeds a temporal proximity threshold, or has been reached or exceeded.

61. The computer-implemented method in claim 52 wherein the interface pre-populates data item fields corresponding to specification sheet data item fields.

62. The computer-implemented method in claim 52 wherein the download options include a letterhead option and comprise:
the letter of medical necessity;
an assessment only;
a combined assessment and justification; and
an addendum to the assessment and seating and mobility evaluation.

63. The computer-implemented method in claim 52 wherein the interface provides an option to add a resource comprising a title, a URL, and a description, and an option to associate a resource with a diagnosis or a piece of equipment, with a resource rating option.

64. The computer-implemented method in claim 52 wherein the interface provides options to add, edit, and delete pre-populated data from the specification sheet comprising client information, the vendor, a physician, client evaluation date, optional client measurements, client insurance information, client prognosis, the sequence of client evaluation participants, and clinician, including a co-signing clinician option.

65. The computer-implemented method in claim 52 further comprising a photo interface that includes photo upload and deletion options, a text field associated with each photo, and a photo from the specification sheet with associated vendor text.

66. The computer-implemented method in claim 52 wherein the interface provides an option to edit an existing equipment data item pre-populated from the specification sheet by adding current equipment or presenting selectable equipment associated with the clinician's client record.

67. The computer-implemented method in claim 52 wherein the customized comment field further comprises:
presenting the clinician with selectable comment templates that the vendor can preview or place within a text field in the customized comment field; and
presenting the clinician with selectable options to:
save text within the text field as a new comment template; and
update the currently selected comment template with the text currently in the text field.

68. The computer-implemented method in claim 52 wherein the interface provides pre-generated text for a primary equipment data item within a customized comment field, wherein the pre-generated text utilizes template text associated with each particular primary equipment item and requires clinician validation; and
provides options to add, edit, and delete a data item that comprises an equipment data item and its associated customizable comment field, and to rearrange the order of appearance of equipment data items in the letter of medical necessity.

69. The computer-implemented method in claim 52 wherein the interface provides pre-generated text for textual data items comprising introductory text, general justification text, and narrative text specific to a client identified in the specification sheet based upon the clinician's text previously generated for the client by the clinician, wherein the clinician is required to customize a textual data item, and wherein the interface provides an option for a customized comment field for a textual data item.

70. A non-transitory computer-readable medium for generating a letter of medical necessity through an interface containing instructions that, when executed by a processor, cause the processor to perform a method comprising:
notifying a clinician of a specification sheet from a vendor specifying the clinician and containing a deadline;
receiving a response from the clinician through a network that indicates acceptance or rejection of the specification sheet, wherein the interface sends the response to the vendor;
after receiving an acceptance response from the clinician, presenting the clinician with:
potential data item matches from an account associated with the clinician that correspond to a data item type in the specification sheet;
an option to create a data item utilizing a data item of the same data item type from the specification sheet; and
an option to create a data item without specification sheet data;
providing a final review with options to add, edit, and delete a data item that requires clinician input indicating validation of the data item;
providing vendor comments associated with a data item to the clinician, wherein the data item corresponds to a specification sheet data item containing the vendor comments;
presenting the clinician letter of medical necessity download options;
notifying the vendor of the clinician's letter of medical necessity download; and
wherein each customized comment field comprises:
creating, prior to starting the instant letter of medical necessity, a comment template based on an earlier letter of medical necessity by:
identifying, within textual input associated with the prior letter of medical necessity, each matching instance corresponding to data-types comprising: a prior person's name, possessive versions of the prior person's name, and gender-specific pronouns matching the prior person's gender; and
replacing each matching instance with a placeholder corresponding to its matching data-type; and
outputting, on the display device, the comment template by replacing each data-type placeholder with corresponding client data from the instant letter of medical necessity.

71. The non-transitory computer-readable medium in claim 70 wherein the interface provides the clinician, prior to the response, a selectable preview of the specification sheet.

72. The non-transitory computer-readable medium in claim 70 upon receiving a rejecting response, the interface:
presents the clinician with a comment field for text to accompany the response; and
requires the vendor to resubmit the specification sheet to the clinician.

73. The non-transitory computer-readable medium in claim 70 wherein prior to receiving a specification sheet notification, the interface presents an option to the clinician to create preliminary text, for either a new client or an existing client, wherein the preliminary text is added to a letter of medical necessity after acceptance of a specification sheet by the clinician.

74. The non-transitory computer-readable medium in claim 70 wherein the interface provides the clinician an option to create a letter of medical necessity prior to accepting a specification sheet.

75. The non-transitory computer-readable medium in claim 70 wherein the interface provides an option to undo an automated match of a data item in the specification sheet with a corresponding item associated with the clinician's account.

76. The non-transitory computer-readable medium in claim 70 wherein a data item comprises a client, a physician, primary equipment, and a vendor, wherein the interface indicates whether the vendor in the specification sheet matches the vendor that submitted the specification sheet.

77. The non-transitory computer-readable medium in claim 70 wherein the interface presents optional data items, that if included in the specification sheet, comprise client assessment, client measurements, client photos, and text accompanying the client photos, wherein the interface provides the clinician with an option to input new versions of these data items.

78. The non-transitory computer-readable medium in claim 70 wherein the interface notifies the clinician of:
a deadline reminder from a vendor;
a deadline modification by a vendor; and
a deadline that exceeds a temporal proximity threshold, or has been reached or exceeded.

79. The non-transitory computer-readable medium in claim 70 wherein the interface pre-populates data item fields corresponding to specification sheet data item fields.

80. The non-transitory computer-readable medium in claim 70 wherein the download options include a letterhead option and comprise:
the letter of medical necessity;
an assessment only;
a combined assessment and justification; and
an addendum to the assessment and seating and mobility evaluation.

81. The non-transitory computer-readable medium in claim 70 wherein the interface provides an option to add a resource comprising a title, a URL, and a description, and an option to associate a resource with a diagnosis or a piece of equipment, with a resource rating option.

82. The non-transitory computer-readable medium in claim 70 wherein the interface provides options to add, edit, and delete pre-populated data from the specification sheet comprising client information, the vendor, a physician, client evaluation date, optional client measurements, client insurance information, client prognosis, the sequence of client evaluation participants, and clinician, including a co-signing clinician option.

83. The non-transitory computer-readable medium in claim 70 further comprising a photo interface that includes photo upload and deletion options, a text field associated with each photo, and a photo from the specification sheet with associated vendor text.

84. The non-transitory computer-readable medium in claim 70 wherein the interface provides an option to edit an existing equipment data item pre-populated from the specification sheet by adding current equipment or presenting selectable equipment associated with the clinician's client record.

85. The non-transitory computer-readable medium in claim 70 wherein the customized comment field further comprises:
presenting the clinician with selectable comment templates that the vendor can preview or place within a text field in the customized comment field; and
presenting the clinician with selectable options to:
save text within the text field as a new comment template; and
update the currently selected comment template with the text currently in the text field.

86. The non-transitory computer-readable medium in claim 70 wherein the interface provides pre-generated text for a primary equipment data item within a customized comment field, wherein the pre-generated text utilizes template text associated with each particular primary equipment item and requires clinician validation; and
provides options to add, edit, and delete a data item that comprises an equipment data item and its associated customizable comment field, and to rearrange the order of appearance of equipment data items in the letter of medical necessity.

87. The non-transitory computer-readable medium in claim 70 wherein the interface provides pre-generated text for textual data items comprising introductory text, general justification text, and narrative text specific to a client identified in the specification sheet based upon the clinician's text previously generated for the client by the clinician, wherein the clinician is required to customize a textual data item, and wherein the interface provides an option for a customized comment field for a textual data item.

88. A system for generating a letter of medical necessity through an interface comprising:
a memory; and
a processor coupled to said memory, said processor configured to:
notify a clinician of a specification sheet from a vendor specifying the clinician and containing a deadline;
receive a response from the clinician through a network that indicates acceptance or rejection of said specification sheet, wherein said interface sends said response to the vendor;
after receiving an acceptance response from the clinician, said interface presents the clinician with:
potential data item matches from an account associated with the clinician that correspond to a data item type in said specification sheet;
an option to create a data item utilizing a data item of said same data item type from said specification sheet; and
an option to create a data item without specification sheet data;
provide a final review with options to add, edit, and delete a data item that requires clinician input indicating validation of said data item;
provide vendor comments associated with a data item to the clinician, wherein said data item corresponds to a specification sheet data item containing the vendor comments;
present the clinician letter of medical necessity download options;
notify the vendor of said clinician's letter of medical necessity download; and
wherein each customized comment field comprises:
creating, prior to starting the instant letter of medical necessity, a comment template based on an earlier letter of medical necessity by:
identifying, within textual input associated with the prior letter of medical necessity, each matching instance corresponding to data-types comprising: a prior person's name, possessive versions of the prior person's name, and gender-specific pronouns matching the prior person's gender; and
replacing each matching instance with a placeholder corresponding to its matching data-type; and
outputting, on the display device, the comment template by replacing each data-type placeholder with corresponding client data from the instant letter of medical necessity.

89. The system in claim 88 wherein said interface provides the clinician, prior to said response, a selectable preview of said specification sheet.

90. The system in claim 88 whereupon receiving a rejecting response from the clinician, said interface:
presents the clinician with a comment field for text to accompany said response; and
requires the vendor to resubmit said specification sheet to the clinician.

91. The system in claim 88 wherein prior to receiving a specification sheet notification, said interface presents an option to the clinician to create preliminary text, for either a new client or an existing client, wherein said preliminary text is added to a letter of medical necessity after acceptance of a specification sheet by the clinician.

92. The system in claim 88 wherein said interface provides the clinician an option to create a letter of medical necessity prior to accepting a specification sheet.

93. The system in claim 88 wherein said interface further comprises an option to undo an automated match of a data item in said specification sheet with a corresponding item associated with said clinician's account.

94. The system in claim 88 wherein a data item comprises a client, a physician, primary equipment, and a vendor, wherein said interface indicates whether the vendor in said specification sheet matches the vendor that submitted said specification sheet.

95. The system in claim 88 wherein said interface presents optional data items, that if included in said specification sheet, comprise client assessment, client measurements, client photos, and text accompanying said client photos, wherein said interface provides the clinician with an option to input new versions of these data items.

96. The system in claim 88 wherein said interface notifies the clinician of:
a deadline reminder from a vendor;
a deadline modification by a vendor; and
a deadline that exceeds a temporal proximity threshold, or has been reached or exceeded.

97. The system in claim 88 wherein said interface pre-populates data item fields corresponding to specification sheet data item fields.

98. The system in claim 88 wherein said download options include a letterhead option and comprise:
the letter of medical necessity;
an assessment only;
a combined assessment and justification; and
an addendum to said assessment and seating and mobility evaluation.

99. The system in claim 88 wherein said interface further comprises an option to add a resource comprising a title, a URL, and a description, and an option to associate a resource with a diagnosis or a piece of equipment, with a resource rating option.

100. The system in claim 88 wherein said interface further comprises options to add, edit, and delete pre-populated data from said specification sheet comprising client information, the vendor, a physician, client evaluation date, optional client measurements, client insurance information, client prognosis, said sequence of client evaluation participants, and clinician, including a co-signing clinician option.

101. The system in claim 88 wherein said interface further comprises a photo interface that includes photo upload and deletion options, a text field associated with each photo, and a photo from said specification sheet with associated vendor text.

102. The system in claim 88 wherein said interface further comprises an option to edit an existing equipment data item pre-populated from said specification sheet by adding current equipment or presenting selectable equipment associated with said clinician's client record.

103. The system in claim 88 wherein said customized comment field further comprises:
presenting the clinician with selectable comment templates that the vendor can preview or place within a text field in said customized comment field; and
presenting the clinician with selectable options to:
save text within said text field as a new comment template; and
update the currently selected comment template with said text currently in said text field.

104. The system in claim 88 wherein said interface further comprises pre-generated text for a primary equipment data item within a customized comment field, wherein said pre-generated text utilizes template text associated with each particular primary equipment item and requires clinician validation; and
provides options to add, edit, and delete a data item that comprises an equipment data item and its associated customizable comment field, and to rearrange said order of appearance of equipment data items in said letter of medical necessity.

105. The system in claim 88 wherein said interface further comprises pre-generated text for textual data items comprising introductory text, general justification text, and narrative text specific to a client identified in said specification sheet based upon said clinician's text previously generated for the client by the clinician, wherein the clinician is required to customize a textual data item, and wherein said interface provides an option for a customized comment field for a textual data item.
